(19) United States
(12) Patent Application Publication
(10) Pub. No.: US 2019/0266562 A1
(43) Pub. Date: Aug. 29, 2019

(54) INFORMATION SYSTEM, INFORMATION PROCESSING METHOD AND RECORDING MEDIUM

(71) Applicant: TOYOTA JIDOSHA KABUSHIKI KAISHA, Toyota-shi (JP)

(72) Inventors: Kei Kanaoka, Nagoya-shi (JP); Shun Maeda, Nisshin-shi (JP); Yoshihiro Murozaki, Nisshin-shi (JP); Hiroko Tsujimura, Nagoya-shi (JP); Daiki Kaneichi, Nisshin-shi (JP); Kuniaki Jinnai, Nagoya-shi (JP)

(73) Assignee: TOYOTA JIDOSHA KABUSHIKI KAISHA, Toyota-shi (JP)

(21) Appl. No.: 16/273,217

(22) Filed: Feb. 12, 2019

(30) Foreign Application Priority Data
Feb. 23, 2018 (JP) 2018-030764

(51) Int. Cl. G06Q 10/08; G06Q 10/02; G08G 1/14; G05D 1/02

(52) U.S. Cl. CPC G06Q 10/0836; G06Q 10/0832; G05D 1/0212; G08G 1/14; G06Q 10/02

(57) ABSTRACT

Provided is an information system to manage use for pickup or delivery of one or more regions in a vehicle permitted to be used as a pickup-delivery destination of a pickup-delivery article. The information system includes a processor to accept a reservation for use of the one or more regions for pickup or delivery of the pickup-delivery article, to acquire detection information about a placing state of the pickup-delivery article for the one or more regions, from a sensor to detect the placing state of the pickup-delivery article in the vehicle, to identify an occupation time for the pickup-delivery article placed on the one or more regions, based on the detection information, and to give a notice of information about payment of a use charge calculated based on the occupation time, to a reservation source terminal in the reservation for use for pickup or delivery of the pickup-delivery article.

### INCORPORATION BY REFERENCE

The disclosure of Japanese Patent Application No. 2018-030764 filed on Feb. 23, 2018 including the specification, drawings and abstract is incorporated herein by reference in its entirety.

### BACKGROUND

### 1. Technical Field

The present disclosure relates to an information system that manages a pickup-delivery service for using a predetermined region in a vehicle as an acceptance place for a pickup-delivery article, an information processing method, and a recording medium.

### 2. Description of Related Art

In recent years, as means for efficiently performing acceptance of a pickup-delivery article (parcel) between a user of a pickup-delivery service and a delivery business operator to perform pickup and delivery, there has been developed a trunk sharing system that uses a luggage compartment of a vehicle designated by the user, as an acceptance place for the pickup-delivery article. For example, Japanese Patent Application Publication No. 2006-206225 (JP 2006-206225 A) describes that mutual authentication with a parcel receiving vehicle side is performed by a business-use communication device provided in a vehicle of a courier at the time of delivery of a delivery article, and the delivery article is put into a trunk. Even when a receiver is absent, it is possible to receive the delivery article with the parcel receiving vehicle.

### SUMMARY

In the trunk sharing system, it is assumed that a vehicle registered as the parcel receiving vehicle is shared by a plurality of persons other than the possessor. However, in the technology disclosed in JP 2006-206225 A, a use charge for the vehicle registered as the parcel receiving vehicle when the vehicle is used by the plurality of persons is not considered.

The present disclosure provides a charging technology that allows securement of fairness among a plurality of users.

An information system according to a first aspect of the present disclosure is configured to manage use of one or more regions in a vehicle for pickup or delivery, the vehicle being permitted to be used as a pickup-delivery destination of a pickup-delivery article. The information system includes a processor. The processor is configured to accept a reservation for the use of the one or more regions for the pickup or delivery of the pickup-delivery article. The processor is configured to acquire detection information, from a sensor configured to detect a placing state of the pickup-delivery article in the vehicle, the detection information being information about the placing state of the pickup-delivery article for the one or more regions. The processor is configured to identify an occupation time for the pickup-delivery article placed on the one or more regions, based on the detection information. The processor is configured to give a notice of information to a terminal of a reservation source of the reservation for the use for the pickup or delivery of the pickup-delivery article, the information being relevant to payment of a use charge calculated based on the occupation time.

With this configuration, it is possible to identify the occupation time for the pickup-delivery article placed on the one or more regions in the vehicle for which the reservation for the use for the pickup or delivery is accepted, based on the detection information of the sensor, and it is possible to give, to the terminal of the reservation source, the notice of the information relevant to the payment of the use charge calculated based on the occupation time. As a result, it is possible to give the notice of the use charge that varies depending on the occupation time of a luggage compartment or the like for the pickup-delivery article, and therefore, it is possible to provide a charging technology that allows securement of fairness among a plurality of users.

In the information system according to the first aspect, the processor may be configured to identify a remaining time before an end time of the reservation for the use, based on the occupation time, and to give a notice of information to the terminal of the reservation source, the information being relevant to the remaining time before the end time of the reservation for the use. With this configuration, it is possible to provide a convenient pickup-delivery service to a plurality of users that uses the luggage compartment or the like.

In the information system according to the first aspect, the processor may be configured to acquire a schedule of use of the vehicle, from a terminal of a possessor of the vehicle. The processor may be configured to increase the use charge calculated based on the occupation time, at a predetermined rate, when the reservation for the use falls within a period during which the vehicle is scheduled to be used. With this configuration, it is possible to restrain an extension of the occupation period for the pickup-delivery article in the vehicle designated as the pickup-delivery destination, for the plurality of users that uses the luggage compartment or the like.

In the information system according to the first aspect, the processor may be configured to detect movement of the vehicle, based on change in position information about the vehicle in connection with time elapse. The processor may be configured to reduce the use charge calculated based on the occupation time, by some or all of the use charge, when the processor detects the movement of the vehicle in a state where the pickup-delivery article is placed on the one or more regions. With this configuration, it is possible to compensate a disadvantage of the user relevant to the acceptance of the pickup-delivery article when the vehicle moves in the state where the pickup-delivery article is placed on the luggage compartment or the like.

In the information system according to the first aspect, the processor may be configured to give a notice of the position information about the vehicle, to the terminal of the reservation source, when the processor detects the movement of the vehicle in the state where the pickup-delivery article is placed on the one or more regions. With this configuration, the user can know the position information about the moved vehicle, through a predetermined application, and therefore, it is possible to increase usability when the vehicle moves in the state where the pickup-delivery article is placed on the luggage compartment or the like.

In the information system according to the first aspect, the processor may be configured to acquire position information from the terminal of the reservation source. The processor may be configured to calculate a required time to collect the pickup-delivery article, based on a parking position of the vehicle and the position information acquired from the terminal of the reservation source, in a state where the pickup-delivery article is placed on the one or more regions. The processor may be configured to give a notice of an expected amount of the use charge, to the terminal of the reservation source, the expected amount of the use charge being calculated based on the required time. With this configuration, the user that uses the luggage compartment or the like of the vehicle for the acceptance of the pickup-delivery article can know the use charge in advance, and therefore, convenience increases.

In the information system according to the first aspect, the processor may be configured to estimate an expected collection hour for the pickup-delivery article placed on the one or more regions, based on the required time. The processor may be configured to give a notice of the expected collection hour, to a terminal of a possessor of the vehicle. With this configuration, the vehicle owner that provides use of the luggage compartment or the like to the plurality of users can replan a use schedule for the vehicle, based on the given expected collection hour, and therefore, it is possible to increase usability for the vehicle owner.

An information processing method according to a second aspect of the present disclosure is an information processing method of using an information system configured to manage use of one or more regions in a vehicle for pickup or delivery, the vehicle being permitted to be used as a pickup-delivery destination of a pickup-delivery article. The information system includes a processor. The information processing method including: the processor accepting a reservation for the use of the one or more regions for the pickup or delivery of the pickup-delivery article; the processor acquiring detection information, from a sensor configured to detect a placing state of the pickup-delivery article in the vehicle, the detection information being information about the placing state of the pickup-delivery article for the one or more regions; the processor identifying an occupation time for the pickup-delivery article placed on the one or more regions, based on the detection information; and the processor giving a notice of information to a terminal of a reservation source of the reservation for the use for the pickup or delivery of the pickup-delivery article, the information being relevant to payment of a use charge calculated based on the occupation time.

A non-transitory readable recording medium according to a third aspect of the present disclosure holds a program that makes a processor execute an information processing method, the information processing method being a method for an information system configured to manage use of one or more regions in a vehicle for pickup or delivery, the vehicle being permitted to be used as a pickup-delivery destination of a pickup-delivery article. The program makes the processor execute a control process for the information system. The control process includes: accepting a reservation for the use of the one or more regions for the pickup or delivery of the pickup-delivery article; acquiring detection information, from a sensor configured to detect a placing state of the pickup-delivery article in the vehicle, the detection information being information about the placing state of the pickup-delivery article for the one or more regions; identifying an occupation time for the pickup-delivery article placed on the one or more regions, based on the detection information; and giving a notice of information to a terminal of a reservation source of the reservation for the use for the pickup or delivery of the pickup-delivery article, the information being relevant to payment of a use charge calculated based on the occupation time.

With these aspects of the present disclosure, it is possible to provide a charging technology that allows securement of fairness among a plurality of users.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a diagram showing an exemplary configuration of a trunk sharing system according to the embodiment;

FIG. 2 is a diagram showing an exemplary hardware configuration of an in-vehicle device, a requester terminal, a pickup-delivery person terminal, a sharing management server and a center server;

FIG. 3 is a diagram for describing vehicle information that is disclosed to the pickup-delivery person terminal;

FIG. 4 is a diagram for describing sharing management information;

FIG. 5 is a diagram for describing charging management information;

FIG. 6 is a flowchart showing an exemplary use reservation registration process;

FIG. 7 is a flowchart showing an exemplary process for detecting an occupation period of a luggage compartment or the like for a pickup-delivery article;

FIG. 8 is a flowchart showing an exemplary announcement process to a request user in connection with time elapse after loading completion;

FIG. 9 is a flowchart showing another exemplary announcement process to the request user in connection with time elapse after loading completion;

FIG. 10 is a flowchart showing an exemplary announcement process when a vehicle moves after loading completion;

FIG. 11 is a flowchart showing an exemplary charging and billing process; and

FIG. 12 is a sequence diagram showing an exemplary flow of a pickup-delivery process.

### DETAILED DESCRIPTION OF EMBODIMENTS

Hereinafter, a trunk sharing system according to an embodiment will be described with reference to the drawings. The configuration of the embodiment described below is an example, and the trunk sharing system in the present disclosure is not limited to the configuration of the embodiment.

1. System Configuration

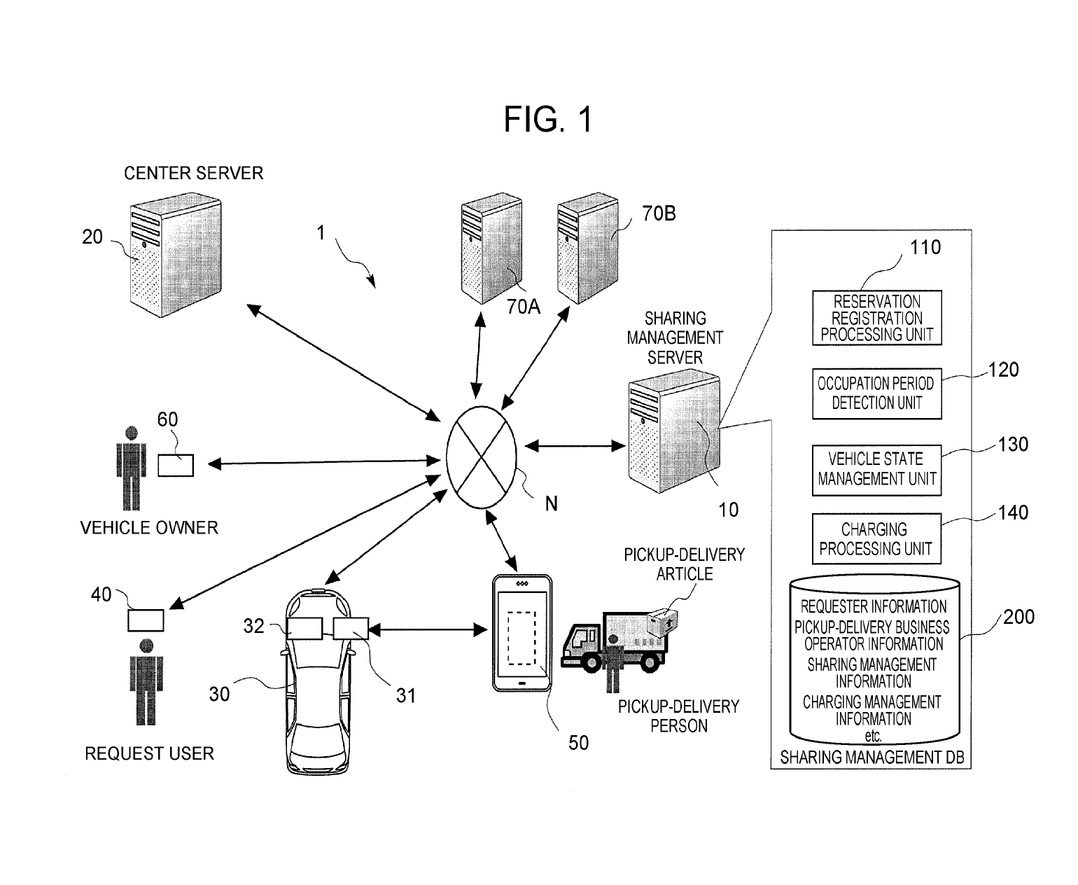

FIG. 1 is a diagram showing an exemplary configuration of a trunk sharing system 1 according to the embodiment. The trunk sharing system 1 is a system for providing a pickup-delivery service in which a vehicle cabin, a luggage compartment (trunk room) or the like of a vehicle 30 is used in common as an acceptance place for a pickup-delivery article (parcel) by a person that requests a pickup-delivery work for the pickup-delivery article and a person that performs the pickup-delivery work for the pickup-delivery article. The vehicle 30 to be used as the acceptance place for the pickup-delivery article is a vehicle that can be locked and unlocked using an electronic key, and is designated by the person that requests the pickup-delivery work. In the embodiment described below, the common use of the vehicle cabin, the luggage compartment or the like of the vehicle 30 is referred to as trunk sharing. Further, the pickup-delivery service to be provided by the trunk sharing system 1 is referred to as a trunk sharing service. Furthermore, the trunk sharing service is also referred to as merely a trunk sharing. The trunk sharing system 1 according to the embodiment provides a pickup-delivery service in which at least a part of the vehicle 30 is occupied in common by a plurality of persons. Hereinafter, “sharing” includes at least one of common use and common occupation. In the trunk sharing system 1, the “person that requests the pickup-delivery work” is a user that uses the vehicle cabin, the luggage compartment or the like of the vehicle 30 as a delivery destination of the parcel or a pickup destination of the parcel. The user includes a user that uses a vehicle rented for the trunk sharing as the delivery destination or the pickup destination, in addition to a vehicle owner that is the possessor or right holder of the vehicle 30. In the embodiment, users other than the vehicle owner are also referred to as “request users”. The vehicle owner has a possessor terminal 60, and the request user has a requester terminal 40. Further, the “person that performs the pickup-delivery work” is a business operator that delivers a parcel to the vehicle cabin, the luggage compartment or the like of the vehicle 30 as the delivery destination, or picks up a parcel put in the vehicle cabin, the luggage compartment or the like of the vehicle 30, and is also referred to as a “pickup-delivery user”. The pickup-delivery user includes a courier that provides a home delivery service for delivering a delivery article or the like to the delivery destination and a logistics operator that provides a transport service for a delivery article or the like between sites. The pickup-delivery person is a staff of the pickup-delivery user, or is a practitioner that receives commission from the pickup-delivery user and performs the pickup-delivery work. The pickup-delivery person has a pickup-delivery person terminal 50. Examples of the vehicle cabin, the luggage compartment or the like to be used as the acceptance place for the pickup-delivery article include a region on the vehicle 30 that allows the storage of the pickup-delivery article and the locking and unlocking, as exemplified by a hood, an assistant driver's seat and a rear seat of the vehicle 30. Hereinafter, the vehicle cabin, the luggage compartment or the like is also referred to as merely “the luggage compartment or the like”.

The trunk sharing system 1 exemplified in FIG. 1 includes a sharing management server 10, a center server 20, a communication device 32 mounted on the vehicle 30, a requester terminal 40, a pickup-delivery person terminal 50 and a possessor terminal 60, which are mutually connected via a network N. Further, the trunk sharing system 1 includes an external server 70A that is operated by the pickup-delivery user and an external server 70B that is operated, for example, by an e-commerce operator to perform an internet shopping business. The external server 70A and the external server 70B are mutually connected via the network N, similarly. The network N includes a public network such as the internet, a wireless network such as a cellular phone communication network, a dedicated network such as a virtual private network (VPN), and a network such as a local area network (LAN). Further, the in-vehicle device 31 mounted on the vehicle 30 is connected to the requester terminal 40 and the pickup-delivery person terminal 50, for example, through a short-range wireless communication or the like. To the network N, unillustrated other center servers 20, unillustrated other communication devices 32 of vehicles 30, unillustrated other requester terminals 40, unillustrated other pickup-delivery person terminals 50, unillustrated other possessor terminal 60, and unillustrated other external servers 70A, 70B can be connected.

The sharing management server 10 is operated by a business operator (hereinafter, also referred to as a “provider”) that provides the trunk sharing service as a business. Examples of the provider include a courier that provides a home delivery service for delivering a delivery article or the like to the delivery destination, a logistics operator that provides a transport service for a delivery article or the like between sites, and an e-commerce operator that performs an internet shopping business. The provider may be a cooperation organization that is operated by some of a courier, a logistics operator and an e-commerce operator. Further, the provider may be an intermediate agency such as a trading company or an agency that performs mediation of sale of the vehicle 30, or may be a rental business operator or a lease business operator that provides a rental service, a lease service or the like for the vehicle 30. A plurality of rental business operators or lease business operators may function as a provider in cooperation. Alternatively, a cooperation organization constituted by some of a manufacturer or dealer of the vehicle 30, a section of the manufacturer, an affiliated company, a trading company, an agency, a rental business operator, a lease business operator, a courier, a logistics operator and an e-commerce operator may function as a provider in cooperation.

For example, the provider provides the trunk sharing system to a plurality of request users that shares the luggage compartment or the like and a pickup-delivery user, by operation of a service site including the sharing management server 10 and cooperation with the center server 20 that manages key information allowing the locking and unlocking of the luggage compartment of the vehicle 30.

The sharing management server 10 includes a sharing management database (DB) 200. The sharing management server 10 provides at least information processing functions of a reservation registration processing unit 110, an occupation period detection unit 120, a vehicle state management unit 130 and a charging processing unit 140. The sharing management server 10 may include a single processor, or may be an aggregation of a plurality of processors, for example, a system called a cloud system. Similarly, the sharing management DB 200 may be constructed by a single database server or a plurality of database servers.

The sharing management server 10 according to the embodiment accepts a use reservation for the pickup-delivery article in which the vehicle 30 is designated as the pickup-delivery destination, from the requester terminal 40 of the request user. In the requester terminal 40, an application program (hereinafter, also referred to as a “predetermined app”) for using the pickup-delivery service with the trunk sharing system 1 is installed. For example, when the request user requests the pickup-delivery user to deliver an article purchased at an internet shopping site as the pickup-delivery article, the request user can register information relevant to the delivery of the pickup-delivery article, in the sharing management server 10, using the predetermined app. For the use reservation registered for the pickup-delivery article by the request user, for example, the sharing management server 10 according to the embodiment measures an occupation time during which the vehicle 30 is occupied by the pickup-delivery article, and varies a use charge for the vehicle 30 designated as the pickup-delivery destination, depending on the substantial occupation time for the pickup-delivery article. Here, the “substantial occupation time” is a period during which the pickup-delivery article exists in the luggage compartment or the like of the vehicle 30 designated as the pickup-delivery destination, and for example, is a period after the pickup-delivery person sets the pickup-delivery article in the luggage compartment or the like and before the request user completes the receiving of the pickup-delivery article. Similarly, the “substantial occupation time” is a period after the request user to request the pickup of the pickup-delivery article sets the pickup-delivery article in the luggage compartment or the like and before the pickup-delivery person completes the pickup of the pickup-delivery article. The use charge for the vehicle 30 determined depending on the substantial occupation time for the pickup-delivery article is demanded to the request user through the sharing management server 10. The sharing management server 10 according to the embodiment varies the use charge depending on an elapsed time after the pickup-delivery article is put in the luggage compartment or the like, and thereby, it is possible to secure fairness among a plurality of request users that uses the vehicle 30 as the pickup-delivery destination.

For example, the occupation period for the pickup-delivery article is measured based on detection information from various sensors mounted on the vehicle 30. Examples of the sensors that can be mounted on the vehicle 30 include an imaging device such as a camera, and a pressure distribution detection sensor. As described later, the sharing management server 10 acquires the detection information (a picked image, pressure distribution data) detected through the above sensors, at the time of the locking and unlocking of the luggage compartment or the like. For example, the detection information is acquired through the communication device 32 mounted on the vehicle 30. Then, based on the detection information about the luggage compartment or the like acquired through the communication device 32 in connection with the locking and unlocking, the sharing management server 10 identifies putting of the pickup-delivery article in the luggage compartment or the like or taking of the pickup-delivery article put in the luggage compartment or the like. The sharing management server 10 recognizes the identified putting of the pickup-delivery article in the luggage compartment or the like or the identified taking of the pickup-delivery article put in the luggage compartment or the like, in association with hour information. Based on the hour information, the sharing management server 10 can measure the period after the pickup-delivery person sets the pickup-delivery article in the luggage compartment or the like and before the request user completes the receiving of the pickup-delivery article, as the substantial occupation period of the vehicle 30 for the pickup-delivery article.

When the pickup-delivery article exists in the luggage compartment or the like, the sharing management server 10 detects whether the vehicle 30 designated as the pickup-delivery destination moves. By detecting whether the vehicle 30 moves, the sharing management server 10 can take into consideration circumstances such as an extension of the occupation period due to the movement (for example, reduces the use charge), when the sharing management server 10 demands the use charge to the user (request user).

Further, when the sharing management server 10 accepts the use reservation, the sharing management server 10 may determine a use reservation date and a use time period, based on a use schedule of the vehicle owner for the vehicle 30. For example, the use schedule for the vehicle 30 is acquired by the possessor terminal 60 equipped with the predetermined app. The sharing management server 10 can avoid a state where the request user to use the vehicle 30 as the pickup-delivery destination of the pickup-delivery article cannot take the pickup-delivery article due to the vehicle movement, in advance.

Furthermore, the sharing management server 10 or a computer that cooperates with the sharing management server 10 may learn the use schedule of the vehicle owner, and may predict a day of week and a period of time when the vehicle 30 is likely to be used. For example, the sharing management server 10 or the computer that cooperates with the sharing management server 10 stores the use schedule for the vehicle 30 acquired through the possessor terminal 60. Then, the sharing management server 10 or the computer that cooperates with the sharing management server 10 analyzes the use frequency of the vehicle 30 and the like, from the stored use schedule, and estimates, for example, a day of week and a period of time when the vehicle 30 will be used. The sharing management server 10 or the computer that cooperates with the sharing management server 10 may use the estimated day of week and the estimated a period of time as reference data, and may perform learning by reflecting a day of week and a period of time when the vehicle was actually used, on the reference data. For example, the sharing management server 10 or the like may estimate the occupation probability of the vehicle for each day of week and each period of time, using a statistical algorithm. For example, the occupation probability of the vehicle may be calculated based on history data in the last one year, the last one month, the last one week or the like. The sharing management server 10 or the like may estimate the occupation probability of the vehicle for each day of week and each period of time, by deep learning.

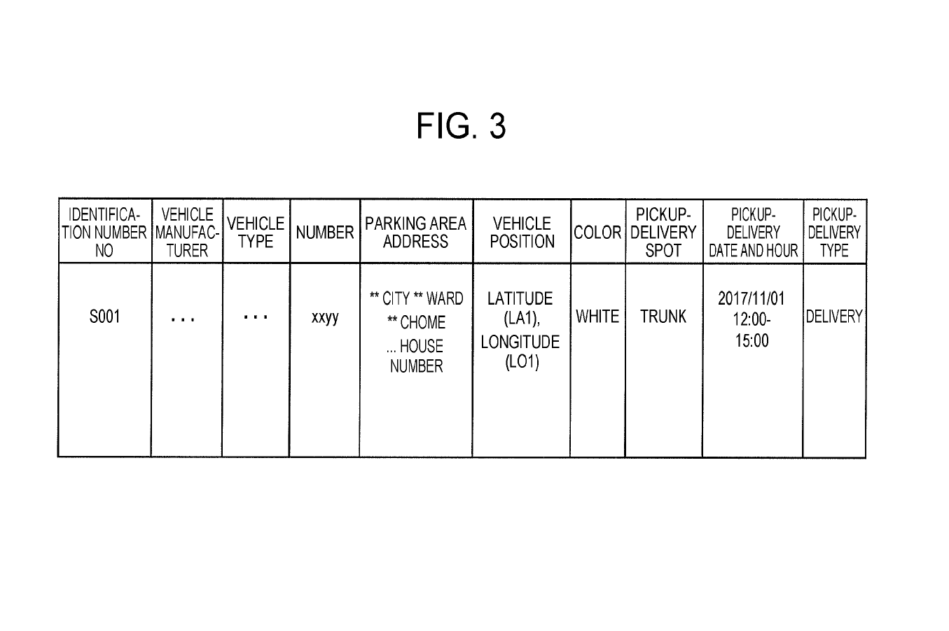

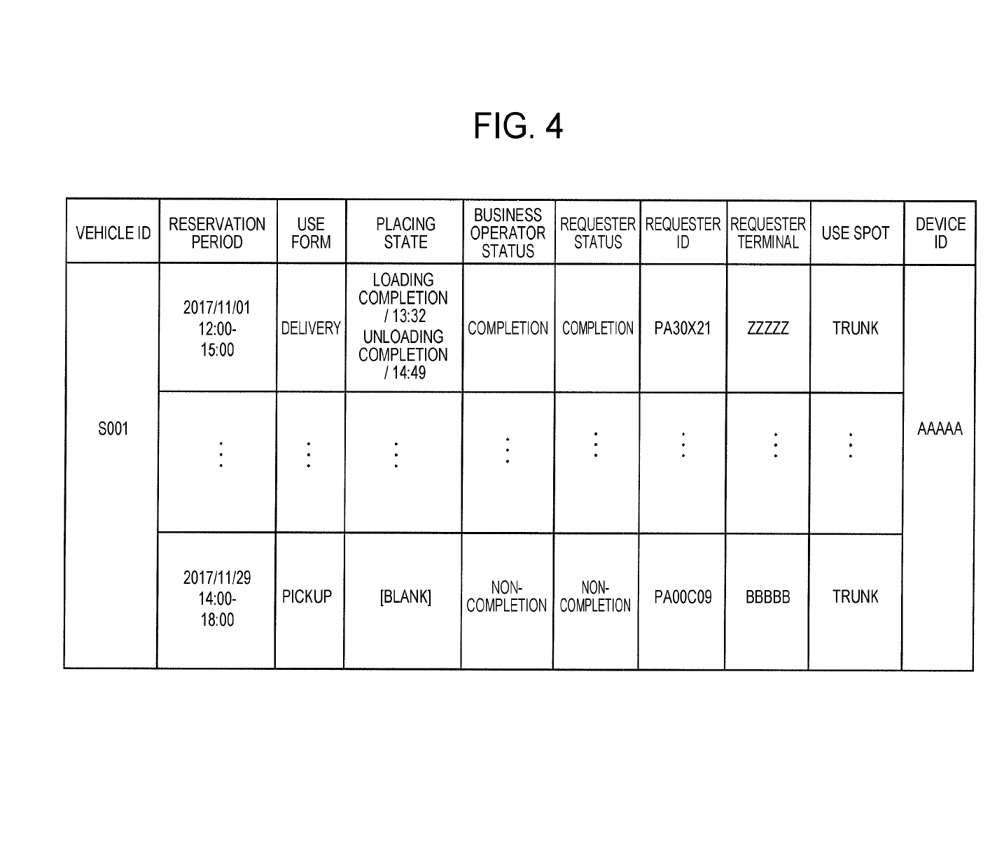

For example, elements such as information about the vehicle exemplified in FIG. 3, the history stored as the sharing management information (FIG. 4) relevant to the vehicle, and the sharing management information stored about the requester are set as an input parameter array (xi, i=1, 2, . . . ). The sharing management server 10 or the like executes a convolution process of performing the product-sum computation of the input parameters with weighting factors (wi, j. l (j is a value of 1 to the number M of elements in the convolution computation, and l is a value of 1 to the number L of layers)), and a pooling process of decimating some of determination results of an activation function for determining the result of the convolution process and an activation for the convolution process. Then, the sharing management server 10 or the like repeatedly executes the above process across the layers L, and outputs the occupation probability for each day of week, each period of time and each region of the vehicle, as an output parameter (or an output parameter array) (yk, k=1, . . . , P), from a full connected layer at the final stage (neural network process). By such a recognition process based on the deep learning using the neural network with the plurality of layers, the sharing management server 10 or the like can estimate the occupation probability for each day of week, each period of time and each region of the vehicle. For the input parameter array (xi, i=1, 2, . . . ), all of the above elements do not need to be used, and some of the above elements may be used. The input parameter array is not limited to the above elements, and it is allowable to use other information, for example, various elements such as the type of the parcel, season, information of whether it is a holiday or a weekday, and the job of the user. Meanwhile, the above recognition process may be performed for combinations of a plurality of vehicles (Cn, n=1, 2, . . . ) and a plurality of users (Hm, m=1, 2, . . . ). An actual history of the information about the vehicle exemplified in FIG. 3, the history stored as the sharing management information (FIG. 4) relevant to the vehicle, and the history of the sharing management information stored about the requester are set as input parameters. Then, using the actual occupation probability in the past for each day of week, each period of time and each region of the vehicle as training data, deep learning is executed, and the weighting factors are adjusted.

The sharing management server 10 or the like extracts the above input parameters for a particular vehicle and a particular user, inputs the extracted input parameters to the neural network after the adjustment of the weighting factors (that is, after the learning), and estimates the occupation probability of the vehicle in the future for each day of week and each period of time. The neural network may be hardware that is incorporated in the sharing management server 10 or the like, may be virtually implemented by a computer program, or may be implemented in a dedicated learning machine that cooperates with the sharing management server 10 or the like. For example, the sharing management server 10 sets the use charge to a relatively high amount, when the accepted use reservation date and use time period are the expected use date and expected use time period for the vehicle owner, or the sharing management server 10 sets the use charge to a relatively low amount, when the accepted use reservation date and use time period are other than the expected use date and expected use time period for the vehicle owner. Thereby, it is likely that the request user to use the vehicle 30 as the pickup-delivery destination of the pickup-delivery article is led to reserve the use on date and hour other than the expected use date and expected use time period.

For example, when the sharing management server 10 accepts an issuance request for the key information for temporarily performing the locking and unlocking of the vehicle 30 from the request user or the pickup-delivery person, the sharing management server 10 gives a notice of the issuance request for the key information, to the center server 20. For example, the sharing management server 10 gives a notice of an issuance request including information for identifying the vehicle 30, the acceptance place in the vehicle 30, and the like, to the center server 20. For example, the center server 20 issues the key information for making the requester terminal 40 or the pickup-delivery person terminal 50 function as a temporary electronic key, based on the information for identifying the vehicle 30, the acceptance place (use spot) in the vehicle 30 and information about the hour when the issuance request is received. For example, the issued key information is sent to the requester terminal 40 or the pickup-delivery person terminal 50 through the sharing management server 10.

The center server 20 is a computer such as a personal computer (PC), a workstation (WS) or a server of a management business operator that manages the key information allowing the locking and unlocking of the vehicle 30. The center server 20 may be constituted by only a single processor, or may be constituted by an aggregation of a plurality of processors, for example, by a cloud system. For example, the management business operator having the center server 20 is a section or an affiliated company of the manufacturer of the vehicle 30, or a business operator that receives commission from the manufacturer or the like and operates the management business for the key information.

The center server 20 manages the key information allowing the locking and unlocking of the luggage compartment or the like of the vehicle 30 that is previously registered as the acceptance place of the pickup-delivery article, in cooperation with the sharing management server 10. The center server 20 accepts the issuance request for the key information from the cooperating sharing management server 10, and issues the key information corresponding to a region in the vehicle 30 that is designated as the acceptance place for the pickup-delivery article. The “key information” is authentication information for using the vehicle 30 and allowing the locking and unlocking using the electronic key. For example, vehicle-side authentication information is registered in the in-vehicle device 31 mounted on the vehicle 30. The center server 20 manages the vehicle-side authentication information in association with identification information about the vehicle 30 on which the in-vehicle device 31 is mounted.

For example, when the center server 20 accepts the issuance request for the key information from the sharing management server 10, the center server 20 issues the authentication information temporarily allowing the locking and unlocking of the vehicle 30, as the key information (one-time key), based on the vehicle-side authentication information associated with the vehicle 30. The issued one-time key is transmitted to the requester terminal 40 or pickup-delivery person terminal 50 from which the issuance request has been performed, through the network N. For example, when the authentication to the in-vehicle device 31 succeeds with the one-time key sent to the requester terminal 40 or the pickup-delivery person terminal 50, the request user or the pickup-delivery person can lock and unlock the luggage compartment or the like of the vehicle 30 through the in-vehicle device 31.

The communication device 32 mounted on the vehicle 30 is a wireless communication device that can be connected to the network N. The communication device 32 is connected to an in-vehicle network such as a controller area network (CAN) in the vehicle 30. Various electronic control units (ECU) mounted on the vehicle 30 are connected to the in-vehicle network. For example, the communication device 32 acquires a variety of information corresponding to the current position of the vehicle 30, as exemplified by traffic jam information, road condition, weather information and news information, in cooperation with an unillustrated car navigation device and global positioning system (GPS) unit mounted on the vehicle 30. In the embodiment, the communication device 32 acquires the picked image and pressure distribution data of the luggage compartment or the like detected through various sensors in connection with the locking and unlocking of the vehicle 30, and gives a notice of the acquired detection information, to the sharing management server 10. Further, the communication device 32 gives a notice of position information (latitude, longitude) about the vehicle, to the sharing management server 10. Through the GPS unit or the like, the position information is acquired at the times of the start and stop of an engine of the vehicle 30, and during traveling, is acquired at a regular interval or for each regular traveling distance. For example, the sharing management server 10 can manage the movement of the vehicle 30, based on a status value and the position information that are given from the communication device 32.

2. Hardware Configuration

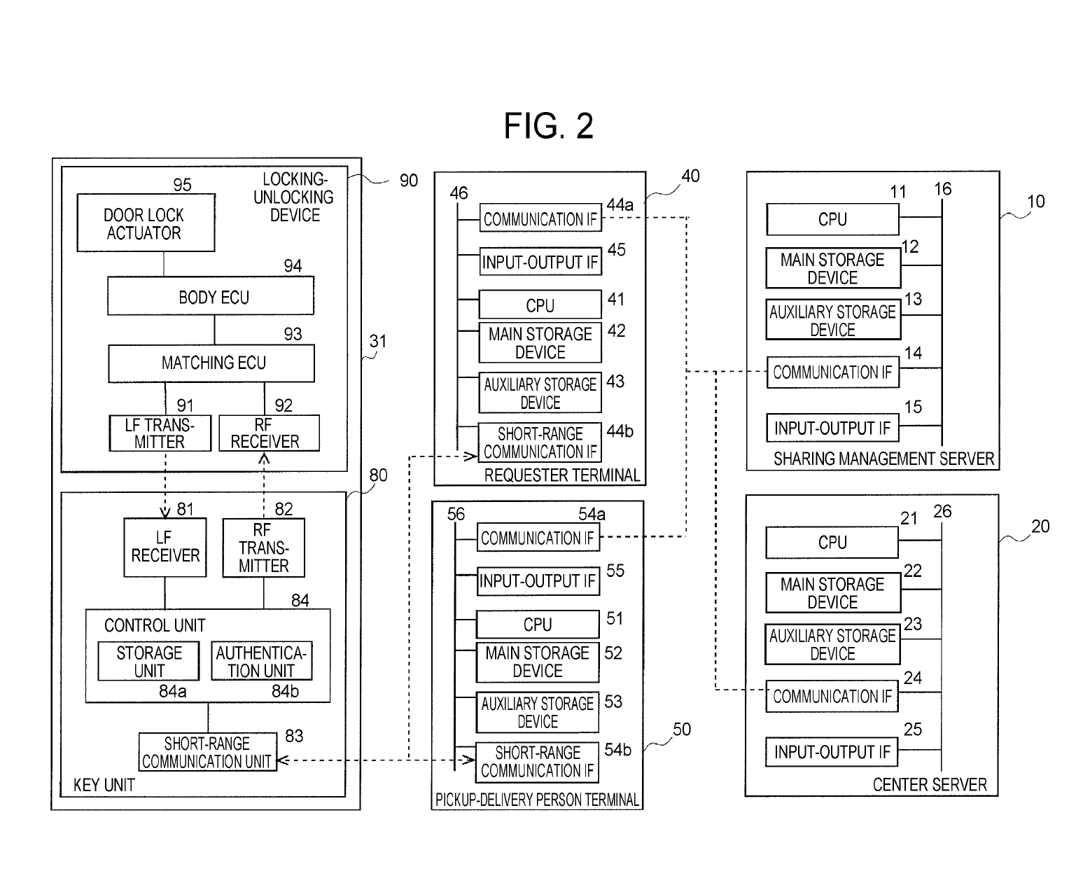

FIG. 2 is a diagram showing an exemplary hardware configuration of the sharing management server 10, the center server 20, the in-vehicle device 31, the requester terminal 40 and the pickup-delivery person terminal 50 that constitute the trunk sharing system 1. The configuration of the possessor terminal 60 exemplified in FIG. 1 is the same as the configuration of the requester terminal 40, and therefore, is omitted in FIG. 2. Further, the configuration of the external servers 70A, 70B exemplified in FIG. 1 is the same as the configuration of the sharing management server 10, and therefore, is omitted in FIG. 2. In the embodiment, the in-vehicle device 31 is configured to include a key unit 80 and a locking-unlocking device 90. The key unit 80 includes the same wireless interface as an electronic key (hereinafter, referred to as a portable device) called a smart key, and performs communication with the existing locking-unlocking device 90 constituting the in-vehicle device 31. The request user to use the luggage compartment or the like of the vehicle 30 as the pickup-delivery destination of the article can lock and unlock the luggage compartment, the vehicle cabin or the like of the vehicle 30 without using a physical key, for example, when the key unit 80 authenticates the authentication information held in the requester terminal 40. That is, the key unit 80 performs the short-range wireless communication with the requester terminal 40 or pickup-delivery person terminal 50 (hereinafter, referred to as the requester terminal 40 or the like) holding the authentication information, and determines whether to behave as the electronic key of the vehicle 30, based on the result of the authentication for the requester terminal 40 or the like.

For example, when the requester terminal 40 or the like accesses the luggage compartment or the like of the vehicle 30 for delivering or picking up the pickup-delivery article, the requester terminal 40 or the like requests the center server 20 to issue the authentication information for locking and unlocking the luggage compartment or the like, through the sharing management server 10, as described above. The authentication information transmitted from the requester terminal 40 or the like to the key unit 80 is compared with the vehicle-side authentication information previously stored in the key unit 80. When the authentication process succeeds, the requester terminal 40 or the like is authenticated as a terminal that rightfully actuates the in-vehicle device 31. When the requester terminal 40 or the like is authenticated, the key unit 80 transmits a key ID of the vehicle 30 that is previously stored in the key unit 80 and that is associated with the vehicle-side authentication information, to the locking-unlocking device 90, together with a locking-unlocking signal. When the key ID received from the key unit 80 coincides with a key ID that is previously stored in the locking-unlocking device 90, the locking-unlocking device 90 locks and unlocks the vehicle 30. The key ID that is previously stored in the key unit 80 may be encrypted with the vehicle-side authentication information. In this case, when the authentication process of the requester terminal 40 or the like succeeds, the key unit 80 decrypts the key ID with the vehicle-side authentication information, and then, transmits the key ID to the locking-unlocking device 90. The key unit 80 and the locking-unlocking device 90 operate with electric power that is supplied from a battery mounted on the vehicle 30. However, the key unit 80 and the locking-unlocking device 90 may operate with electric power that is supplied from a general battery other than the battery mounted on the vehicle 30.

The locking-unlocking device 90 is a device for locking and unlocking the door of the vehicle cabin or luggage compartment of the vehicle 30, and is an existing device that constitutes a part of a smart key system. The locking-unlocking device 90 locks and unlocks the door of the vehicle 30, in response to a locking signal and an unlocking signal that are transmitted from the portable device corresponding to the vehicle 30 with an electric wave in a radio frequency (hereinafter, referred to as RF) band. Further, the locking-unlocking device 90 has a function to transmit an electric wave in a low frequency (hereinafter, referred to as LF) band, for searching the portable device.

In the embodiment, instead of the portable device, the key unit 80 transmits and receives the electric waves in the RF band and LF band, for the locking-unlocking device 90, and thereby, the locking and unlocking of the door of the luggage compartment or the like of the vehicle 30 are controlled. Hereinafter, unless otherwise mentioned, descriptions will be made assuming that the communication destination of the locking-unlocking device 90 is only the key unit 80.

The locking-unlocking device 90 is configured to include an LF transmitter 91, an RF receiver 92, a matching ECU 93, a body ECU 94 and a door lock actuator 95. The LF transmitter 91 is means for transmitting an electric wave in a low frequency band (for example, 100 KHz to 300 KHz) for searching (polling) the key unit 80. For example, the LF transmitter 91 is incorporated near a center console or steering wheel in the vehicle cabin. The RF receiver 92 is means for receiving an electric wave in a high frequency band (for example, 100 MHz to 1 GHz) transmitted from the key unit 80. The RF receiver 92 is incorporated at a place in the vehicle cabin.

The matching ECU 93 is a computer that performs a control to lock and unlock the door of the vehicle cabin or luggage compartment of the vehicle 30, based on the signal (the locking signal or the unlocking signal) transmitted from the key unit 80 with the electric wave in the RF band. For example, the matching ECU 93 is constituted by a microcomputer. Hereinafter, the locking signal and the unlocking signal will be also referred to as a locking-unlocking signal. The term “locking-unlocking signal” is a collective term, and means at least one of the locking signal and the unlocking signal.

The matching ECU 93 authenticates the locking-unlocking signal transmitted from the key unit 80, as a signal transmitted from a rightful device. Specifically, the matching ECU 93 determines whether a key ID included in the locking-unlocking signal coincides with a key ID previously stored in a storage unit of the matching ECU 93. Then, based on the result of the determination, the matching ECU 93 transmits an unlocking command or a locking command to the body ECU 94. The unlocking command or the locking command is transmitted through an in-vehicle network such as a CAN.

The body ECU 94 is a computer that performs a body control for the vehicle 30. The body ECU 94 has a function to unlock and lock a vehicle cabin door or luggage compartment door of the vehicle 30 concurrently or independently, by controlling the door lock actuator 95 based on the unlocking command or locking command received from the matching ECU 93. The hood of the vehicle 30 is accessed, for example, by operating a predetermined component provided near a driver's seat after the unlocking of the vehicle cabin door. The matching ECU 93 and the body ECU 94 may be integrated.

The door lock actuator 95 is an actuator that locks and unlocks a boarding door or a rear gate of the vehicle 30, or the luggage compartment door to be opened and closed at the time of loading or unloading the parcel in the luggage compartment. The door lock actuator 95 operates based on a signal transmitted from the body ECU 94. The door lock actuator 95 may be configured to be capable of locking and unlocking the boarding door, rear gate and luggage compartment door of the vehicle 30 independently.

Next, the key unit 80 will be described. The key unit 80 is a device that is disposed at a predetermined position (for example, within a glove box) in the vehicle cabin of the vehicle 30. The key unit 80 has a function to authenticate the requester terminal 40 or the like while performing the short-range wireless communication with the requester terminal 40 or the like, and a function to transmit the locking-unlocking signal using an electric wave in an RF band, based on the authentication result. The key unit 80 is configured to include an LF receiver 81, an RF transmitter 82, a short-range communication unit 83, and a control unit 84.

The LF receiver 81 is means for receiving a polling signal transmitted from the locking-unlocking device 90 with an electric wave in an LF band. The LF receiver 81 includes an antenna (hereinafter, referred to as an LF antenna) for receiving the electric wave in the LF band. The RF transmitter 82 is means for transmitting the locking-unlocking signal to the locking-unlocking device 90 with an electric wave in an RF band.

The short-range communication unit 83 is means for performing communication with the requester terminal 40 or the like. The short-range communication unit 83 performs communication in a short range (a range allowing communication between the interior and exterior of the vehicle cabin), using a predetermined wireless communication standard.

In the embodiment, the short-range communication unit 83 performs data communication in the Bluetooth® Low Energy standard (hereinafter, referred to as BLE). BLE is a low-power communication standard of Bluetooth, and is characterized in that pairing between devices is not required and the communication can be started shortly after a partner is detected. Although BLE is exemplified in the embodiment, another wireless communication standard may be used. For example, Near Field Communication (NFC), Ultra Wide Band (UWB), WiFi® or the like may be used.

The control unit 84 is a computer that performs the short-range wireless communication with the requester terminal 40 or the like through the short-range communication unit 83 and that performs a control to authenticate the requester terminal 40 or the like and a control to transmit the locking-unlocking signal based on the authentication result. For example, the control unit 84 is constituted by a microcomputer.

The control unit 84 includes a storage unit 84a and an authentication unit 84b. In the storage unit 84a, a control program for controlling the key unit 80 is stored. The control unit 84 may realize various functions including the authentication unit 84b, when an unillustrated central processing unit (CPU) executes the control program stored in the storage unit 84a. For example, the control unit 84 realizes a function to receive the polling signal transmitted from the locking-unlocking device 90 as an electric wave in an LF band, through the LF receiver 81, a function to transmit the locking-unlocking signal, as an electric wave in an RF band, to the locking-unlocking device 90 through the RF transmitter 82, a function to process the communication with the requester terminal 40 or the like that is performed through the short-range communication unit 83, and a function to generate the locking-unlocking signal when the authentication of the requester terminal 40 or the like by the authentication unit 84b succeeds.

The authentication unit 84b authenticates the requester terminal 40 or the like, based on the authentication information included in a locking request or unlocking request (hereinafter, collectively referred to as a locking-unlocking request) transmitted from the requester terminal 40 or the like. Specifically, the authentication unit 84b compares the vehicle-side authentication information stored in the storage unit 84a and the authentication information transmitted from the requester terminal 40 or the like, and determines that the authentication succeeds, when the two pieces of authentication information satisfy a predetermined relation. The authentication unit 84b determines that the authentication fails, when the two pieces of authentication information do not satisfy the predetermined relation. The predetermined relation includes a case where the vehicle-side authentication information stored in the storage unit 84a and the authentication information transmitted from the requester terminal 40 or the like coincide with each other, a case where the results of a predetermined encryption process, decryption process or the like using the two pieces of authentication information (the vehicle-side authentication information and the authentication information transmitted from the requester terminal 40 or the like) coincide with each other, and a case where the result of a decryption process for one of the two pieces of authentication information coincides with the result for the other of the two pieces of authentication information.

When the authentication of the requester terminal 40 or the like by the authentication unit 84b succeeds, the locking-unlocking signal generated in response to the request received from the requester terminal 40 or the like is transmitted to the locking-unlocking device 90 through the RF transmitter 82. The method of the authentication to be performed by the authentication unit 84b may be a method of simply comparing the two pieces of authentication information and checking the coincidence as described above, or may be a method using an asymmetric cryptography. Hereinafter, as necessary for description, the vehicle-side authentication information stored in the key unit 80 is referred to as device authentication information, and the authentication information transmitted from the requester terminal 40 or the like is referred to terminal authentication information. The key unit 80 transmits the key ID to the locking-unlocking device 90, together with the locking-unlocking signal.

For example, the sharing management server 10 has a general processor configuration. The sharing management server 10 includes a CPU 11, a main storage device 12, an auxiliary storage device 13, a communication interface (IF) 14 and an input-output interface (IF) 15, which are mutually connected by a connection bus 16. Each of the main storage device 12 and the auxiliary storage device 13 is a computer-readable recording medium. For each of the constituent elements, multiple devices may be provided, and some of the constituent elements may be excluded.

The CPU 11 is a central processing unit that controls the whole of the processor. The CPU 11 is also called a microprocessor unit (MPU) or a computer. The CPU 11 is not limited to a single processor, and may have a multiprocessor configuration. Further, a single CPU connected by a single socket may have a multicore configuration. For example, the CPU 11 provides functions in accordance with predetermined purposes, by loading programs stored in the auxiliary storage device 13 in a working area of the main storage device 12, in an executable manner, and executing the programs through control of peripheral devices.

The programs to be executed by the CPU 11, data to be processed by the CPU 11, and the like are stored in the main storage device 12. Examples of the main storage device 12 include a flash memory, a random access memory (RAM) and a read only memory (ROM). The auxiliary storage device 13 stores a variety of programs and a variety of data in a recording medium, in a readable and writable manner. Examples of the auxiliary storage device 13 include a flash memory, an erasable programmable ROM (EPROM), a silicon disk and a hard disk drive (HDD). Further, examples of the auxiliary storage device 13 may include portable recording media such as disc recording media, as exemplified by a universal serial bus (USB) memory, a compact disc (CD) and a digital versatile disc (DVD). For example, an operating system (OS), various programs, various tables and the like are stored in the auxiliary storage device 13. For example, the OS includes a communication interface program that exchanges data with another information processing device connected to the network N through the communication IF 14.

The communication IF 14 is a communication interface with the network N. Examples of the communication IF include a LAN interface board and a wireless communication circuit for wireless communication. The input-output IF 15 is an interface for inputting and outputting data for a device connected to the computer. For example, an input device such as a keyboard, a touch panel, a pointing device including a mouse, a microphone and the like is connected to the input-output IF 15. An operation instruction or the like from an operator that operates an input device is accepted through the input-output IF 15. For example, a display device such as a liquid crystal display (LCD), an electroluminescence (EL) panel and an organic EL panel, and an output device such as a speaker are connected to the input-output IF 15. Data and information to be processed by the CPU 11 and data and information to be stored in the main storage device 12 or the auxiliary storage device 13 are output through the input-output IF 15.

By the execution of programs by the CPU 11, the sharing management server 10 provides at least information processing functions of the reservation registration processing unit 110, the occupation period detection unit 120, the vehicle state management unit 130 and the charging processing unit 140. However, at least some of the processing functions may be provided by a digital signal processor (DSP), an application specific integrated circuit (ASIC), a graphics processing unit (GPU) or the like. Further, at least some of the processing functions may be provided by a field-programmable gate array (FPGA), a dedicated large scale integration (LSI) such as a numerical processor and an image processor, or another digital circuit.

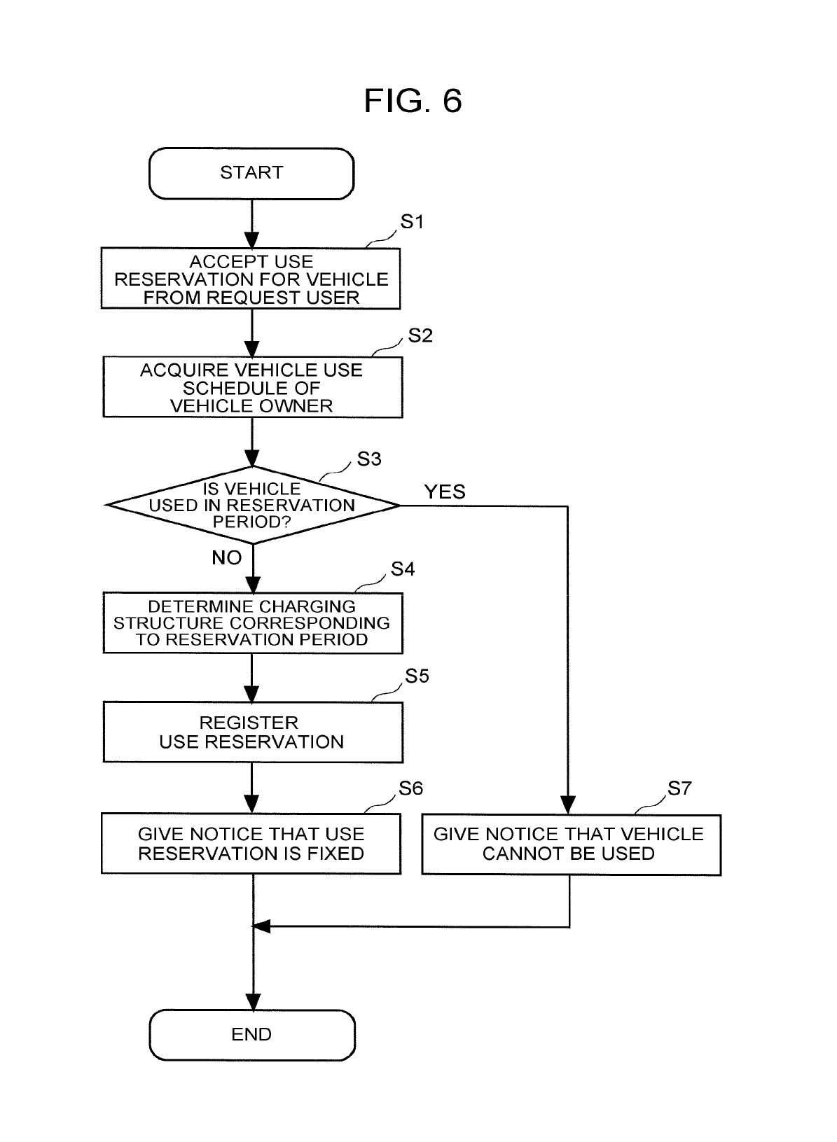

For example, when the use reservation for the vehicle 30 input through the requester terminal 40 satisfies a predetermined condition, the reservation registration processing unit 110 registers the use reservation in requester information of the sharing management DB 200. The occupation period detection unit 120 detects the occupation period for the pickup-delivery article placed on the luggage compartment or the like. The vehicle state management unit 130 manages the movement state of the vehicle 30, and the like. The charging processing unit 140 calculates the use charge depending on the occupation period for the pickup-delivery article and the like, and demands payment of the calculated use charge, to the request user. Detailed processes in the reservation registration processing unit 110, the occupation period detection unit 120, the vehicle state management unit 130 and the charging processing unit 140 will be described later, with use of FIG. 6 to FIG. 11.

Similarly to the sharing management server 10, the center server 20 includes a CPU 21, a main storage device 22, an auxiliary storage device 23, a communication IF 24 and an input-output IF 25, which are mutually connected by a connection bus 26. The configurations of the CPU 21, the main storage device 22, the auxiliary storage device 23, the communication IF 24 and the input-output IF 25 are the same as the configurations of the CPU 11, the main storage device 12, the auxiliary storage device 13, the communication IF 14 and the input-output IF 15 of the sharing management server 10 and therefore, descriptions therefor are omitted.

The center server 20 includes an unillustrated vehicle management database that is constructed in the auxiliary storage device 23 or the like. The key information is managed in association with vehicle attribute information about the vehicle 30 that is used as the pickup-delivery destination of the pickup-delivery article. For example, the vehicle attribute information includes identification information for uniquely identifying the possessor of the vehicle, identification information about the possessor terminal 60, address, name, contact address, the model of the vehicle 30, manufacturing year, displacement, vehicle type, color, manufacturing number, insurance number, license plate (car number), and the like. The identification information about the possessor terminal 60 includes the telephone number, IP address, mail address, media access control (MAC) address and others of the possessor terminal 60. The vehicle attribute information includes information for identifying the parking position of the vehicle 30, identification information about the communication device 32 mounted on the vehicle 30, and the like. The information for identifying the parking position of the vehicle 30 includes address information (parking area address) indicating the location of a parking area where the vehicle 30 is parked, and information (latitude, longitude) indicating the parking position in the parking area. For example, the information indicating the parking position is acquired from the communication device 32 mounted in the vehicle 30 or a car navigation device having a communication function. The identification information about the communication device 32 includes the IP address, MAC address and others of the communication device 32.

For example, each of the requester terminal 40 and the pickup-delivery person terminal 50 is a small-size computer such as a smartphone, a cellular phone, a tablet terminal, a personal information terminal and a wearable computer (a smartwatch or the like). The requester terminal 40 may be a PC that is connected to the sharing management server 10 through the network N.

The requester terminal 40 includes a CPU 41, a main storage device 42, an auxiliary storage device 43, a communication IF 44a, a short-range communication IF 44b and an input-output IF 45, which are mutually connected by a connection bus 46. The configurations of the CPU 41, the main storage device 42, the auxiliary storage device 43 and the input-output IF 45 are the same as the configurations of the CPU 11, the main storage device 12, the auxiliary storage device 13 and the input-output IF 15 of the sharing management server 10, and therefore, descriptions therefor are omitted. For example, the communication IF 44a is a communication circuit for accessing a public network such as the internet through a wireless network such as a cellular phone communication network and performing data communication with the sharing management server 10 and the like. The short-range communication IF 44b is a communication circuit for performing short-range communication in accordance with a predetermined communication standard. Examples of the predetermined communication standard include BLE, NFC and UWB. The input-output IF 45 may include an input device such as a push button, and may include an input device for inputting a picture or image, as exemplified by a camera.

For example, when the CPU 41 executes a browser program, the requester terminal 40 is connected to a server to be operated by an e-commerce operator that performs an internet shopping business, and the like. Through an operation input by the request user, the requester terminal 40 can designate the information about the vehicle 30 that can be used in common with the pickup-delivery user, as the pickup-delivery destination of the purchased article. Further, when the CPU 41 executes the predetermined app, the requester terminal 40 is connected to the sharing management server 10. Through an operation input by the request user, the requester terminal 40 performs a use reservation registration for the pickup-delivery article in which a predetermined region in the vehicle 30 is designated as the pickup-delivery destination. Information for identifying the vehicle 30 registered as the pickup-delivery destination of the pickup-delivery article is disclosed to the requester terminal 40 after the use reservation, as a content described in Hyper Text Markup Language (HTML) or the like.

Similarly to the requester terminal 40, the pickup-delivery person terminal 50 includes a CPU 51, a main storage device 52, an auxiliary storage device 53, a communication IF 54a, a short-range communication IF 54b and an input-output IF 55, which are mutually connected by a connection bus 56. The configurations of them are the same as the configurations of the CPU 41, the main storage device 42, the auxiliary storage device 43, the communication IF 44a, the short-range communication IF 44b and the input-output IF 45 of the requester terminal 40, and therefore, description therefore are omitted.

When the CPU 51 executes the predetermined app, the pickup-delivery person terminal 50 is connected to the sharing management server 10. The information about the vehicle 30 designated as the acceptance place for the pickup-delivery article is disclosed to the pickup-delivery person terminal 50 connected to the sharing management server 10, based on an operation input by the pickup-delivery person. For example, on a display device of the pickup-delivery person terminal 50, as exemplified by an LCD, the information about the vehicle 30 for which the use is reserved by the request user is displayed as a content described in HTML or the like.

FIG. 3 is a diagram for describing disclosure information about the vehicle 30 that is used as the pickup-delivery destination. The disclosure information is disclosed to the requester terminal 40 and the pickup-delivery person terminal 50. FIG. 3 shows an example of the information about the vehicle 30, in a table form. As shown in FIG. 3, the information about the vehicle 30 includes fields of vehicle manufacturer, vehicle type, number, parking place address, vehicle position, color, pickup-delivery spot, pickup-delivery date and hour, and pickup-delivery type. The vehicle manufacturer is information indicating a manufacturer that manufactures the vehicle. The vehicle type is information indicating the type of the vehicle, as exemplified by sedan and minivan. The number is a license number on a sign (number plate) attached to the front and rear of the vehicle. The parking area address is address information indicating the location of a parking area where the vehicle is parked. The vehicle position is information indicating the parking position in the parking area. For example, the vehicle position is indicated by the latitude and longitude of the position where the vehicle is parked. The color is information indicating the kind of the color of the vehicle. Image information about the vehicle may be presented, instead of the color. The pickup-delivery spot is information indicating a region in the vehicle 30 that is used as the pickup-delivery destination. Examples of the pickup-delivery spot include a hood, an assistant driver's seat, a backseat on the assistant driver's seat side, a backseat on the driver's seat side, and a luggage compartment. It can be said that the region stored in the pickup-delivery spot field is “one or more regions in a vehicle that can be used as a pickup-delivery destination of a pickup-delivery article”. The pickup-delivery date and hour is information indicating date and period of time of the pickup-delivery work for the vehicle 30. The pickup-delivery type indicates whether the type of the pickup-delivery work is the pickup or the delivery.

Sharing Management DB

In the sharing management server 10, as shown in FIG. 1, at least requester information, pickup-delivery business operator information, sharing management information and charging management information are stored in the sharing management DB 200.

The requester information is information about the request user for which the use reservation is registered in the sharing management server 10. The requester information includes identification information for uniquely identifying the request user, address, name, contact address other than the requester terminal 40, registration date, and identification information about the requester terminal 40. The identification information about the requester terminal 40 includes the telephone number, IP address, mail address, MAC address and others of the requester terminal 40. The requester information is registered in the sharing management DB 200, by the sharing management server 10 or the computer that cooperates with the sharing management server 10, based on the information at the time of registration. The requester information may be registered in the sharing management DB 200, by the provider or an administrator of the sharing management DB 200 that receives commission from the provider, based on the information at the time of the registration of the use reservation.

The pickup-delivery business operator information is information about the pickup-delivery user registered in the sharing management server 10. The pickup-delivery business operator information includes identification information for uniquely identifying the pickup-delivery user, name, business operator code of the pickup-delivery user, service site information about the pickup-delivery user, contact address, and identification information about the pickup-delivery person terminal 50 to be used by the pickup-delivery person. For example, the identification information about the pickup-delivery person terminal 50 includes the telephone number, IP address, mail address and MAC address of the pickup-delivery person terminal 50, identification number of a support application provided from the sharing management server 10, and the like. The registration of the pickup-delivery business operator information in the sharing management DB 200 is performed similarly to the registration of the requester information.

The sharing management information is information for managing a pickup-delivery state for each vehicle for which the use reservation is accepted as the pickup-delivery destination of the pickup-delivery article. FIG. 4 is a diagram for describing the sharing management information. FIG. 4 shows an example of the sharing management information stored in the sharing management DB 200, in a table form. As shown in FIG. 4, the sharing management information includes fields of vehicle ID, reservation period, use form, placing state, business operator status, requester status, requester ID, requester terminal, use spot, and device ID.

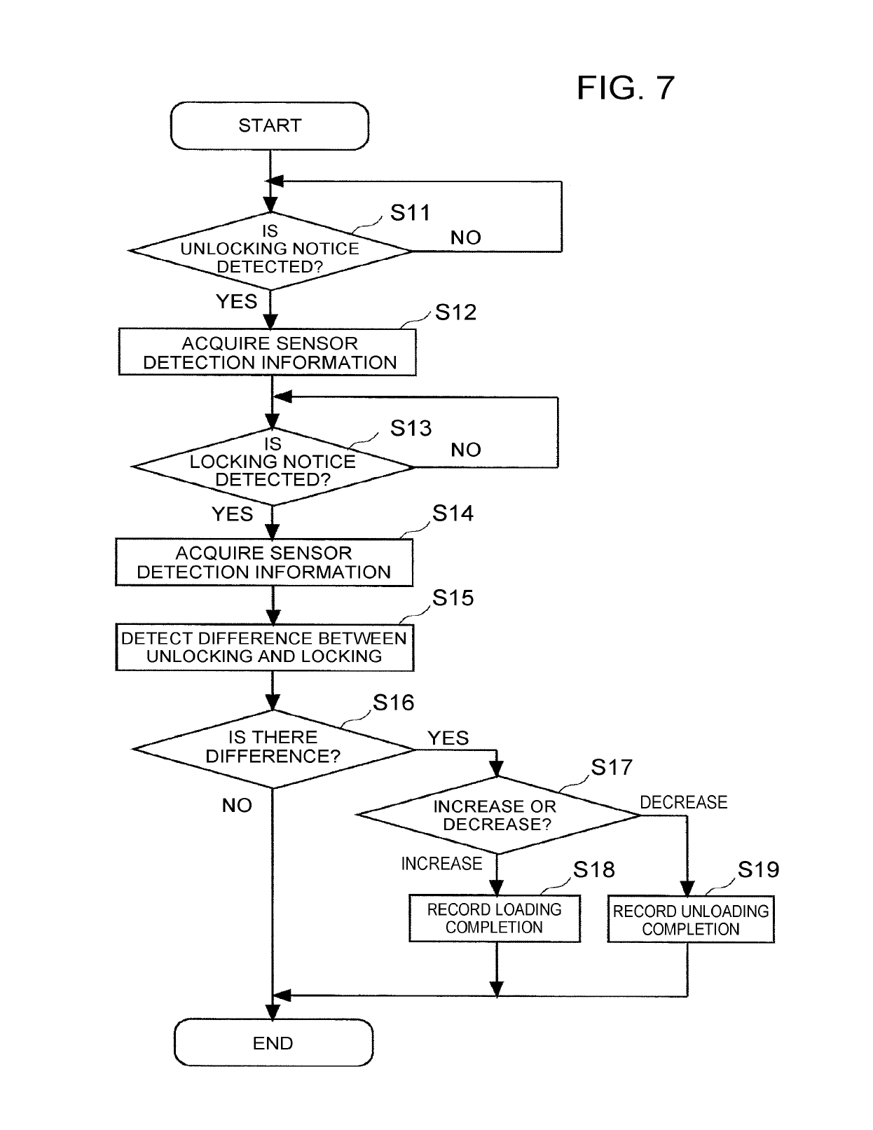

The vehicle ID is identification information for identifying the vehicle 30. For example, the identification information about the vehicle 30 is associated with the vehicle attribute information about the vehicle 30 that is managed by the center server 20. The reservation period is information indicating a pickup-delivery date and pickup-delivery time period in the reservation for the pickup or delivery for the vehicle 30. The use form is information indicating whether the use form is the pickup or the delivery. The placing state is information indicating an occupation state of the pickup-delivery article in the vehicle 30. For example, when the pickup-delivery article is put in the luggage compartment or the like, information of loading completion hour is stored. Further, when the pickup-delivery article put in the luggage compartment or the like is taken off, information of unloading completion hour is stored. As the placing state at the time of the registration of the use reservation for the luggage compartment or the like, a null (blank) state is stored. The information to be stored in the placing state field will be described later, with use of FIG. 7.

The business operator status is information indicating a status of whether the reserved pickup or delivery of the pickup-delivery article by the pickup-delivery person is completed or not. The requester status is information indicating a status of whether the reserved acceptance of the pickup-delivery article by the request user is completed or not. At the time of the registration of the use reservation, “NON-COMPLETION” is stored as an initial value, to the business operator status and the requester status. The requester ID is identification information for identifying the request user. The requester terminal is identification information about the requester terminal 40, and the use spot is information indicating a region in the vehicle that is designated as the pickup-delivery destination of the pickup-delivery article. The use spot is information indicating a region (the hood, the assistant driver's seat, the backseat on the assistant driver's seat side, the backseat on the driver's seat side or the luggage compartment) in the vehicle 30 that is used as the pickup-delivery destination. The device ID is identification information (the IP address, the MAC address and the like) about the communication device 32 mounted on the vehicle 30 that is designated as the pickup-delivery destination of the pickup-delivery article. For example, the device ID is acquired from the vehicle attribute information about the vehicle 30 that is managed by the center server 20. The sharing management information may include identification information about the pickup-delivery person terminal 50 for which the key information is issued, an hour of completion of the pickup-delivery work, and the like.

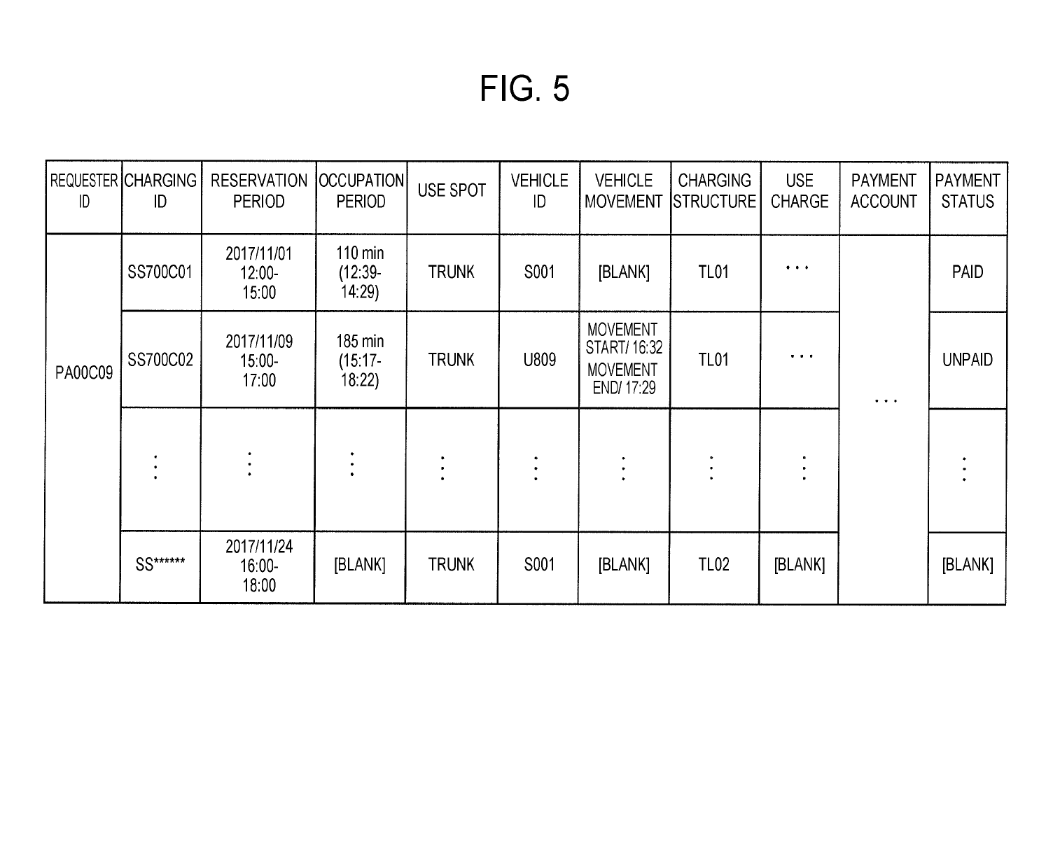

The charging management information is information for managing the use charge of the luggage compartment or the like for the request user for which the use reservation is registered in the sharing management server 10. FIG. 5 is a diagram for describing the charging management information. FIG. 5 shows an example of the charging management information stored in the sharing management DB 200, in a table form. As shown in FIG. 5, the charging management information includes fields of requester ID, charging ID, reservation period, occupation period, use spot, vehicle ID, vehicle movement, charging structure, use charge, payment account and payment status. The fields of the requester ID, the reservation period, the use spot and the vehicle ID are the same as those in FIG. 4. The charging ID is an identification number for uniquely identifying the use charge for each use reservation. The occupation period is information indicating an occupation time (by the minute) of the luggage compartment or the like for the pickup-delivery article in the reservation period. As described later, the occupation time stored in the occupation period field is identified based on the hour information stored in the placing state field of the sharing management information. As the occupation period at the time of the reservation registration, a null (blank) state is stored. In the vehicle movement, information relevant to movement of the vehicle 30 in a state where the pickup-delivery article exists in the luggage compartment or the like is stored. As described later, hour information at the times of the movement start and movement end of the vehicle 30 is stored as the information relevant to the movement of the vehicle 30. When the vehicle 30 does not move, a null state is stored. The charging structure is information for determining the use charge of the luggage compartment or the like. For example, the information is shown as a price table in which charging rates are previously described by the minute. For example, a plurality of price tables is previously held in the auxiliary storage device 13. At the time of the registration of the use reservation, information (identification number) designating the price table determined depending on the use reservation date (day of week) and the reserved time period is stored in the charging structure. As described later, for example, in the case of a use reservation for a day of week and a period of time when the vehicle owner is likely to use the vehicle 30, a price table in which the charging rate is set to a relatively high rate is selected. In the case of a use reservation other than the use reservation for a day of week and a period of time when the vehicle owner is likely to use the vehicle 30, a price table in which the charging rate is set to a relatively low rate is selected. The payment account is information about a payment account of the request user that performs payment of the use charge of the vehicle 30 used as the pickup-delivery destination of the pickup-delivery article. The payment status is information for managing a payment state of the use charge demanded to the request user. In the case where the use charge demanded to the request user has been paid, a status of “PAID” is stored in the payment status. In the case where the use charge demanded to the request user has not been paid, a status of “UNPAID” is stored in the payment status. At the time of the reservation registration, a null state is stored in the payment status.

3. Flow of Process

Next, a charging process depending on the occupation time by the sharing management server 10 according to the embodiment will be described with reference to FIG. 6 to FIG. 11. FIG. 6 is a flowchart showing an exemplary use reservation registration process. By the process exemplified in FIG. 6, whether the vehicle 30 can be used is depending on a vehicle schedule for the vehicle owner and the like, and the charging structure are determined. For example, when the CPU 11 and the like read and execute a variety of programs and a variety of data stored in the auxiliary storage device 13, the sharing management server 10 provides processes exemplified in FIG. 6 to FIG. 11. The process exemplified in FIG. 6 is provided mainly by the information processing function of the reservation registration processing unit 110.

In the flowchart of FIG. 6, the process is started, for example, when the requester terminal 40 executes the predetermined app to register the use reservation for the pickup-delivery article in which the vehicle 30 is designated. The sharing management server 10 accepts information relevant to the use reservation from the requester terminal 40 (S1). For example, the information relevant to the use reservation includes the name of the request user, the information (the number and the like) for identifying the vehicle 30 that is used as the pickup-delivery destination, the reservation period, the pickup-delivery type, and the designation (the luggage compartment, the assistant driver's seat, the backseat on the assistant driver's seat side, the backseat on the driver's seat side, the hood or the like) of the region in the vehicle 30 that is used as the pickup-delivery destination. For example, through the predetermined app of the requester terminal 40, the request user requests search of the vehicle 30 that can be used as the pickup-delivery destination of the pickup-delivery article, to the center server 20 or the computer that cooperates with the center server 20. The search of the vehicle 30 that can be used as the pickup-delivery destination of the pickup-delivery article is performed, for example, based on the address designated by the request user, and the like. For example, the center server 20 or the like gives, to the requester terminal 40, a notice of a search result of vehicle candidates allowing the luggage compartment or the like to be used in the reservation period intended by the request user. The request user selects a vehicle to be used as the pickup-delivery destination of the pickup-delivery article, from the vehicle candidates given to the requester terminal 40. For example, the sharing management server 10 temporarily stores the accepted information relevant to the use reservation, in a predetermined region of the main storage device 12, in association with the IP address of the requester terminal 40, and the like. It is can be said that the “designation of the region in the vehicle 30 that is used as the pickup-delivery destination” accepted in the process of S1 that is executed by the sharing management server 10 is a “reservation for the use of one or more regions in the vehicle that can be used as the pickup or delivery of the pickup-delivery article”. Accordingly, it can be said that the process of S1 that is executed by the sharing management server 10 corresponds to an example of “accepting a reservation for the use of the one or more regions for the pickup or delivery of the pickup-delivery article”.

The sharing management server 10 acquires a vehicle use schedule of the vehicle owner (S2). For example, to the cooperating center server 20, the sharing management server 10 gives a notice of the number or the like included in the information that is accepted from the request user and that is the information for identifying the vehicle 30, and requests the search of the vehicle 30. For example, the center server 20 performs the search in the vehicle management database based on the number information, and extracts the vehicle attribute information associated with the vehicle 30. Then, the center server 20 gives a notice of the extracted vehicle attribute information about the vehicle 30, to the sharing management server 10. The sharing management server 10 temporarily stores the vehicle attribute information about the vehicle 30 given from the center server 20, in a predetermined region of the main storage device 12, and identifies the possessor terminal 60 of the vehicle owner that is included in the vehicle attribute information. Then, the sharing management server 10 acquires the vehicle use schedule of the vehicle owner in the use period (the use date and the period of time), through the predetermined app mounted on the possessor terminal 60. The acquired vehicle use schedule is stored in association with the vehicle attribute information about the vehicle 30. The process of S2 that is executed by the sharing management server 10 corresponds to an example of “acquiring a schedule of use of the vehicle, from a terminal of a possessor of the vehicle”.

The sharing management server 10 compares the reservation period accepted from the request user and the vehicle use schedule corresponding to the reservation period, and determines whether the vehicle 30 is scheduled to be used in the reservation period (S3). In the case where the vehicle 30 is scheduled to be used in the reservation period accepted from the request user (S3, “Yes”), the sharing management server 10 transitions to the process of S7. In the process of S7, the sharing management server 10 gives, to the request user, a notice that the vehicle 30 is scheduled to be used by the vehicle owner in the accepted reservation period and the vehicle 30 cannot be used as the pickup-delivery destination. For example, the request user requests search of the vehicle 30 that can be used as the pickup-delivery destination of the pickup-delivery article, to the center server 20 or the computer that cooperates with the center server 20, and selects an alternative vehicle 30 allowing the luggage compartment or the like to be used in the reservation period intended by the request user. The request user designates the selected alternative vehicle as the pickup-delivery destination, and registers the use reservation in the sharing management server 10 again. After the process of S7, the process of FIG. 6 ends.

In the process of S4, the sharing management server 10 determines the use charge of the luggage compartment or the like corresponding to the reservation period. In the process of S4, as described with use of FIG. 5, the price table that is stored in the charging structure field of the charging management information is determined. For example, the sharing management server 10 refers to correspondence conditions of a plurality of price tables previously stored in the auxiliary storage device 13, and selects a price table corresponding to the reservation period, based on comparison between the correspondence conditions and the reservation period. As described already, the correspondence condition of the price table is associated with a day of week and a period of time when the vehicle owner is likely to use the vehicle 30, a period except for the above day of week and the above period of time, and the like. For example, in the case where the reservation period accepted from the request user falls within the day of week and the period of time when the vehicle owner is likely to use the vehicle, the sharing management server 10 selects a price table in which the charging rate is set to a relatively high rate. In the case where the reservation period accepted from the request user is a period other than the day of week and the period of time when the vehicle owner is likely to use the vehicle, the sharing management server 10 selects a price table in which the charging rate is set to a relatively low rate. The sharing management server 10 transfers information for an instruction of the selected price table (for example, identification number for identifying the price table) to the process of S5. The processes of S3 and S4 that are executed by the sharing management server 10 corresponds to an exemplary management technique of “increasing the use charge calculated based on the occupation time, at a predetermined rate, when the accepted reservation falls within a period during which the vehicle is likely to be used”.

In the process of S5, the sharing management server 10 registers the use reservation accepted from the request user, in the sharing management DB 200. For example, the sharing management server 10 gives the identification information (requester ID) for uniquely identifying the request user, and registers the information accepted in the process of S1, in the requester information of the sharing management DB 200. Further, the sharing management server 10 registers the information accepted in the process of S1 and the vehicle attribute information acquired from the center server 20 in the process of S2, in the sharing management information of the sharing management DB 200. Further, the sharing management server 10 registers the requester ID, the reservation period, the identification information (vehicle ID) given to the vehicle 30, and the identification number of the price table transferred from the process of S4, in an associated manner, in the charging management information of the sharing management DB 200. After the process of S5, the sharing management server 10 transitions to the process of S6.

In the process of S6, the sharing management server 10 gives a notice that the use reservation is fixed, to the requester terminal 40 of the request user. For example, the requester terminal 40 receives the notice that the use reservation for the vehicle 30 is fixed, and the information about the vehicle 30 for which the use reservation is fixed as exemplified in FIG. 3. After the process of S6, the process of FIG. 6 ends.

Next, a flowchart of FIG. 7 will be described. FIG. 7 is a flowchart showing an exemplary process for detecting the occupation period of the luggage compartment or the like for the pickup-delivery article. The process exemplified in FIG. 7 is provided mainly by the information processing function of the occupation period detection unit 120. In FIG. 7, it is assumed that the pickup-delivery person puts the pickup-delivery article in the luggage compartment or the like and thereafter the request user collects the pickup-delivery article or that the request user puts the pickup-delivery article in the luggage compartment or the like and thereafter the pickup-delivery person picks up the pickup-delivery article. In the case where the vehicle 30 is designated as the delivery destination of the pickup-delivery article, the pickup-delivery person, for example, unlocks the luggage compartment or the like, puts the pickup-delivery article, and then locks the luggage compartment or the like. The locking and unlocking of the luggage compartment or the like is performed using the one-time key sent to the pickup-delivery person terminal 50. The request user unlocks the luggage compartment or the like in which the pickup-delivery article is put, using the one-time key sent to the requester terminal 40, collects the put pickup-delivery article, and then locks the luggage compartment or the like. Also in the case where the vehicle 30 is designated as the pickup-delivery destination of the pickup-delivery article, the locking and unlocking of the luggage compartment or the like are performed in the same procedure.

In the flowchart of FIG. 7, the process is started, for example, when the key information is sent to the requester terminal 40 or the pickup-delivery person terminal 50. After the key information is sent, the sharing management server 10 detects an unlocking notice sent from the communication device 32 mounted on the vehicle 30 that is designated as the pickup-delivery destination (S11). In the case where the unlocking notice is detected (S11, “Yes”), the sharing management server 10 transitions to the process of S12. On the other hand, in the case where the unlocking notice is not detected (S11, “No”), the sharing management server 10 waits until the unlocking notice is detected.

In the process of S12, in connection with the unlocking of the vehicle 30, the sharing management server 10 acquires the detection information of the sensors acquired through the communication device 32. Here, the detection information of the sensors acquired through the communication device 32 includes the picked image obtained by photographing the luggage compartment or the like shortly after the unlocking of the vehicle 30, the pressure distribution data of the luggage compartment or the like detected shortly after the unlocking, and the like. The picked image or pressure distribution data shortly after the unlocking includes information indicating the state of the luggage compartment or the like before the pickup or delivery. The sharing management server 10 temporarily stores the acquired detection information in a predetermined region of the main storage device 12, in association with the hour information. Then, the sharing management server 10 detects a locking notice transmitted from the communication device 32 (S13). In the case where the locking notice is detected (S13, “Yes”), the sharing management server 10 transitions to the process of S14. On the other hand, in the case where the locking notice is not detected (S13, “No”), the sharing management server 10 waits until the locking notice is detected.

In the process of S14, in connection with the locking of the vehicle 30, the sharing management server 10 acquires the detection information (the picked image and pressure distribution data of the luggage compartment or the like shortly after the locking) of the sensors acquired through the communication device 32. The picked image or pressure distribution data shortly after the locking include the information indicating the state of the luggage compartment or the like after the pickup or delivery. The sharing management server 10 temporarily stores the acquired detection information in a predetermined region of the main storage device 12, in association with the hour information, and transitions to the process of S15. The processes of S11 to S14 that are executed by the sharing management server 10 correspond to “acquiring detection information, from a sensor configured to detect a placing state of the pickup-delivery article, the detection information being information about the pickup-delivery article for the one or more regions”.

In the process of S15, the sharing management server 10 detects a difference between the sensor detection information (S12) acquired shortly after the unlocking and the sensor detection information (S14) acquired shortly after the locking. For example, the sharing management server 10 compares picked regions of the picked image photographed shortly after the unlocking and picked regions of the picked image photographed shortly after the locking, and identifies whether there is a picked region (difference region) where pixels and the like change between the unlocking and the locking. Similarly, for the pressure distribution data, the sharing management server 10 identifies whether there is a distribution region where the pressure distribution changes between the unlocking and the locking. The sharing management server 10 determines whether there is a difference between the sensor detection information acquired shortly after the unlocking and the sensor detection information acquired shortly after the locking (S16). In the case where there is a difference (S16, “Yes”), the sharing management server 10 transitions to the process of S17. On the other hand, in the case where there is no difference (S16, “No”), the process shown in FIG. 7 ends.

In the process of S17, the sharing management server 10 determines whether the difference in the luggage compartment or the like detected between the unlocking and the locking is a relative increase or a relative decrease. For example, in the case where the difference region identified in the process of S15 changes such that pixels and the like increase relative to the picked image photographed shortly after the unlocking (S17, “Increase”), the sharing management server 10 transitions to the process of S18. On the other hand, for example, in the case where the difference region identified in the process of S15 changes such that the pixels and the like decrease relative to the picked image photographed shortly after the unlocking (S17, “Decrease”), the sharing management server 10 transitions to the process of S19. Also for the pressure distribution data, a similar determination is performed.

In the process of FIG. 18, the sharing management server 10 records, in the sharing management information of the sharing management DB 200, the completion of the placing (loading) of the pickup-delivery article for which the luggage compartment or the like of the vehicle 30 is designated as the pickup-delivery destination. For example, the sharing management server 10 identifies the sharing management information about the vehicle, based on the IP address, MAC address and others of the communication device 32 mounted on the vehicle 30. Then, the sharing management server 10 stores information indicating the loading completion and hour information of the sensor detection information acquired after the locking, in the placing state field on a row including the reservation period corresponding to the hour information of the sensor detection information acquired in the process of S14. As exemplified in FIG. 4, in the placing state field of the sharing management information, the hour information of the sensor detection information acquired after the locking is recorded together with the information indicating the loading completion.

In the process of S19, the sharing management server 10 records, in the sharing management information of the sharing management DB 200, the completion of the receiving (unloading) of the pickup-delivery article for which the luggage compartment or the like of the vehicle 30 is designated as the pickup-delivery destination. The sharing management server 10 identifies the sharing management information about the vehicle 30 similarly to the process of S18, and stores information indicating the unloading completion and hour information of the sensor detection information acquired after the locking, in the placing state field. After the processes of S18 and S19, the process of FIG. 7 ends.

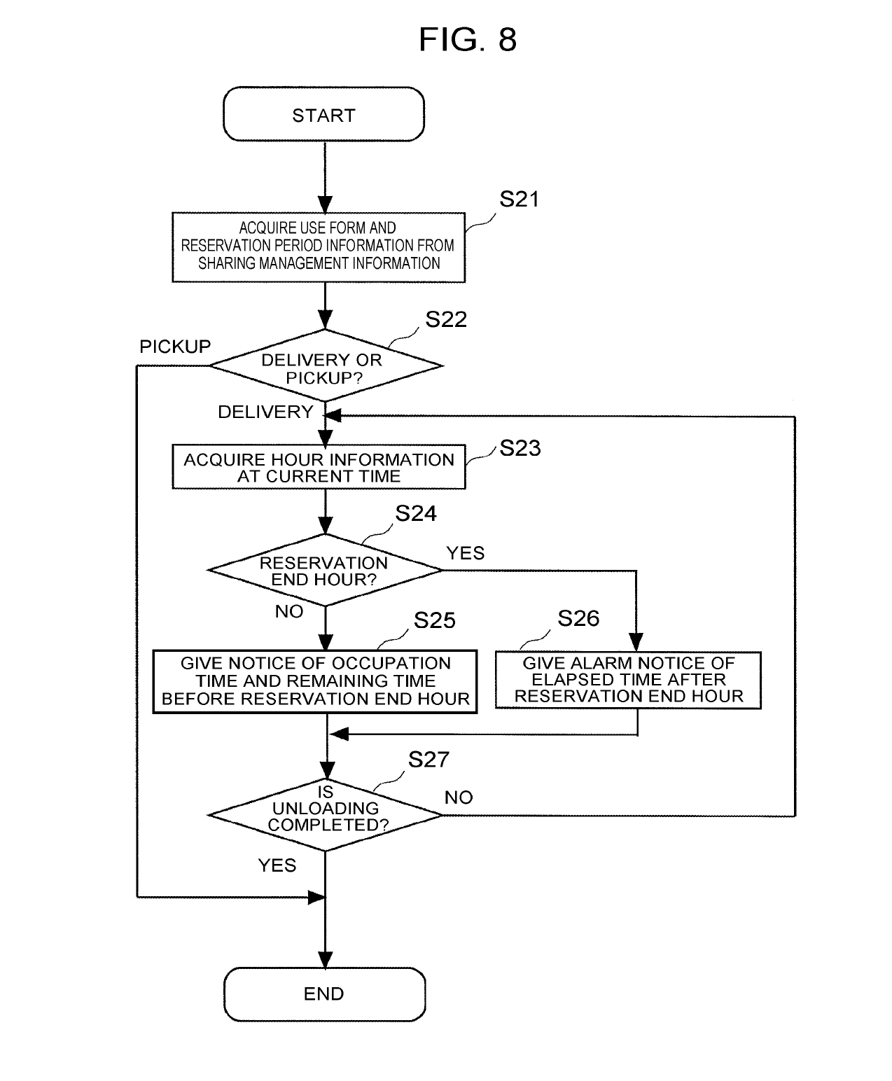

Next, a flowchart of FIG. 8 will be described. FIG. 8 is a flowchart showing an exemplary announcement process to the request user in connection with time elapse after the loading completion. The processes exemplified in FIG. 8 to FIG. 10 are provided mainly by the information processing function of the vehicle state management unit 130. By the process of FIG. 8, various notifications in connection with the time elapse after the loading completion are performed to the request user that designates the vehicle 30 as the delivery destination.

In the flowchart of FIG. 8, the process is started, for example, at the time of the completion of the loading of the pickup-delivery article into the luggage compartment or the like of the vehicle 30. The sharing management server 10 starts the process exemplified in FIG. 8, for example, at the time of the execution of the process of S18 shown in FIG. 7.

From the sharing management information about the vehicle, the sharing management server 10 extracts information stored in each field on a row on which the loading completion is recorded in the placing state field. The extracted information is temporarily stored in a predetermined region of the main storage device 12. Then, from the extracted information, the sharing management server 10 acquires the pickup-delivery type information stored in the use form field and the date and hour information stored in the reservation period field (S21). The date and hour information stored in the reservation period field is transferred to the process of S24.

The sharing management server 10 determines whether the pickup-delivery type information stored in the use form field is the information indicating the delivery or the information indicating the pickup (S22). In the case where the information stored in the use form field indicates the pickup (S22, “Pickup”), the sharing management server 10 ends the process shown in FIG. 8. On the other hand, in the case where the information stored in the use form field indicates the delivery (S22, “Delivery”), the sharing management server 10 transitions to the process of S23.

The sharing management server 10 acquires the hour information at the current time, and transfers the hour information to the process of S24 (S23). The sharing management server 10 identifies an end hour (reservation end hour) of the reservation period, from the date and hour information transferred from S21, and determines whether the current hour has reached the reservation end hour (S24). In the case where the current hour has not reached the reservation end hour (S24, “No”), the sharing management server 10 transitions to the process of S25. On the other hand, in the case where the current hour has reached the reservation end hour (S24, “Yes”), the sharing management server 10 transitions to the process of S26.

In the process of S25, the sharing management server 10 identifies the occupation time for the pickup-delivery article, from the hour information at the current time and the hour information about the loading completion. Further, the sharing management server 10 identifies the remaining time after the current time and before the reservation end hour. Then, the sharing management server 10 gives a notice of the occupation time and the remaining time before the reservation end hour, to the request user. For example, the sharing management server 10 identifies the requester terminal 40 of the request user, from the information stored in the requester terminal field of the sharing management information, and gives the notice of the occupation time and the remaining time before the reservation end hour, to the request user. The sharing management server 10 may give a notice of the use charge depending on the occupation time, together with the notice of the occupation time and the remaining time before the reservation end time. For example, the sharing management server 10 identifies the price table stored in the charging structure field of the charging management information, from the requester ID stored in the requester ID field of the sharing management information and the vehicle ID about the vehicle. Then, for example, the sharing management server 10 calculates the use charge at the current time, based on the charging rate by the minute set in the price table and the occupation time, and gives a notice to the request user. The request user can know a charging condition at the current time. After the process of S25, the process of FIG. 8 transitions to the process of S27.

In the process of S26, the sharing management server 10 identifies an elapsed time after the reservation end hour, from the hour information at the current time and the reservation end hour, and gives an alarm notice of the identified elapsed time, to the request user. The identification of the requester terminal 40 of the request user is the same as the process of S25. The sharing management server 10 identifies the price table stored in the charging structure field of the charging management information, in the same way as the process of S25. The sharing management server 10 may calculate a regular use charge, from the charging rate by the minute set in the price table and the occupation time before the reservation end hour, may calculate an excess charge at the current time, based on the elapsed time, and may give, to the request user, a use charge resulting from adding the excess charge to the regular use charge. Also in this case, the request user can know the charging condition at the current time. After the process of S26, the process of FIG. 8 transitions to the process of S27.

In the process of S27, the sharing management server 10 determines whether the unloading completion hour is recorded in the sharing management information about the vehicle stored in the sharing management DB 200. In the case where the unloading completion hour is recorded in the sharing management information (S27, “Yes”), the sharing management server 10 ends the process of FIG. 8. On the other hand, in the case where the unloading completion hour is not recorded in the sharing management information (S27, “No”), the sharing management server 10 repeats the processes of S23 to S27, as a regular interval. The processes of S21 to S25 that are executed by the sharing management server 10 correspond to “identifying a remaining time before an end time of the reservation for the use, based on the occupation time, and giving a notice of the remaining time before the end time of the reservation for the use, to a terminal of a reservation source for which the reservation for the use for the pickup or delivery of the pickup-delivery article is accepted”.

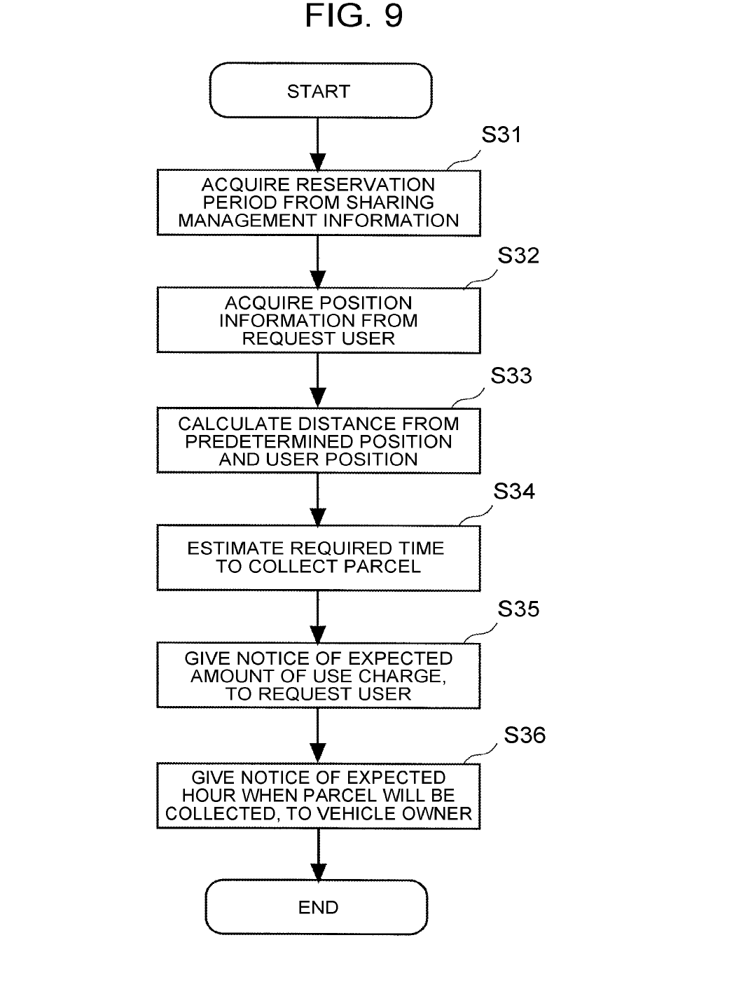

Next, a flowchart of FIG. 9 will be described. FIG. 9 is a flowchart showing another exemplary announcement process to the request user in connection with the time elapse after the loading completion. By the process of FIG. 9, various notifications based on the position of the vehicle in which the pickup-delivery article is loaded in the luggage compartment or the like and the position of the request user that has the requester terminal 40 are performed to the request user and the vehicle owner.

In the flowchart of FIG. 9, the process is started, for example, at the time of the completion of the loading of the pickup-delivery article in the luggage compartment or the like of the vehicle 30. The sharing management server 10 starts the process exemplified in FIG. 9, for example, at the time of the execution of the process of S18 shown in FIG. 7.

From the sharing management information about the vehicle, the sharing management server 10 extracts the information stored in each field on a row on which the loading completion is recorded in the placing state field. The extracted information is temporarily stored in a predetermined region of the main storage device 12. Then, from the extracted information, the sharing management server 10 acquires the date and hour information stored in the reservation period field and the identification information (the IP address or the like) about the requester terminal 40 stored in the requester terminal field (S31). Then, the sharing management server 10 performs a notice request for the position information (latitude, longitude), to the predetermined app mounted on the requester terminal 40. After receiving the notice request for the position information, the predetermined app, for example, acquires the position information about the requester terminal 40 at the current time, from a navigation application mounted on the requester terminal 40, through an application programming interface (API). A notice of the acquired position information about the request user (the requester terminal 40) is given to the sharing management server 10 through the predetermined app.

The sharing management server 10 acquires the position information given from the requester terminal 40 (S32). The sharing management server 10 temporarily stores the acquired position information in a predetermined region of the main storage device 12, in association with the hour information, and transitions to the process of S33. In the process of S33, the sharing management server 10 calculates an inter-point distance between the parking position (predetermined position) of the vehicle 30 and the position of the request user acquired in the process of S32. For example, the sharing management server 10 gives a notice of the device ID of the communication device 32 mounted on the vehicle 30, to the center server 20, and requests the search of the vehicle 30. The center server 20 performs the search in the vehicle management database, based on the given device ID of the communication device 32, and extracts the vehicle attribute information associated with the vehicle 30. A notice of the extracted vehicle attribute information about the vehicle 30 is given to the sharing management server 10. The sharing management server 10 temporarily stores the vehicle attribute information about the vehicle 30 given from the center server 20, in a predetermined region of the main storage device 12, and acquires the parking position information (latitude, longitude) included in the vehicle attribute information. Then, the sharing management server 10 calculates the inter-point distance, based on the parking position of the vehicle 30 and the request user position acquired from the requester terminal 40. The calculated distance is transferred to the process of S34.

In the process of S34, the sharing management server 10 estimates a time required for the request user to collect the pickup-delivery article (parcel) loaded in the luggage compartment or the like. For example, the sharing management server 10 previously holds a table in which distance values and required times are associated with each other, in the auxiliary storage device 13. Then, the sharing management server 10 refers to the above table, and estimates the required time, based on the inter-point distance between the parking position about the vehicle 30 transferred from the process of S33 and the request user position. The table includes a predicted working time to unlock the luggage compartment or the like and collect the pickup-delivery article. The sharing management server 10 transfers the estimated required time to the processes of S35 and S36. The process of S32 that is executed by the sharing management server 10 corresponds to an example of “acquiring position information from the terminal of the reservation source for which the reservation for the use for the pickup or delivery of the pickup-delivery article is accepted”. The processes of S33 and S34 that are executed by the sharing management server 10 correspond to an exemplary management technique of “calculating a required time to collect the pickup-delivery article, based on a parking position of the vehicle and the position information acquired from the terminal of the reservation source, in a state where the pickup-delivery article is placed on the one or more regions”.

In the process of S35, the sharing management server 10 gives a notice of an expected amount of the use charge, to the request user, based on the estimated required time. For example, the sharing management server 10 identifies the price table stored in the charging structure field of the charging management information, from the requester ID stored in the requester ID field of the sharing management information and the vehicle ID of the vehicle. Then, the sharing management server 10 calculates the expected amount of the use charge, based on the charging rate by the minute set in the price table and the estimated required time, and gives the notice to the request user. After the process of S35, the process of FIG. 9 transitions to S36. The process of S35 that is executed by the sharing management server 10 is an exemplary management technique of “giving a notice of an expected amount of the use charge, to the terminal of the reservation source, the expected amount of the use charge being calculated based on the required time”.

In the process of S36, the sharing management server 10 gives, to the vehicle owner, a notice of an expected hour when the pickup-delivery article will be collected, based on the estimated required time. For example, the sharing management server 10 identifies the possessor terminal 60 of the vehicle owner, from the vehicle attribute information about the vehicle 30 acquired from the center server 20 in the process of S33. The sharing management server 10 calculates the expected hour when the request user will collect the pickup-delivery article, by adding the estimated required time to the hour information at the current time. Then, the sharing management server 10 gives a notice of the calculated expected hour, to the possessor terminal 60 of the vehicle owner. After the process of S36, the process of FIG. 9 ends. The process of S36 that is executed by the sharing management server 10 corresponds to an exemplary management technique of “estimating an expected collection hour for the pickup-delivery article placed on the one or more regions, based on the required time, and giving a notice of the expected collection hour, to a terminal of a possessor of the vehicle”.

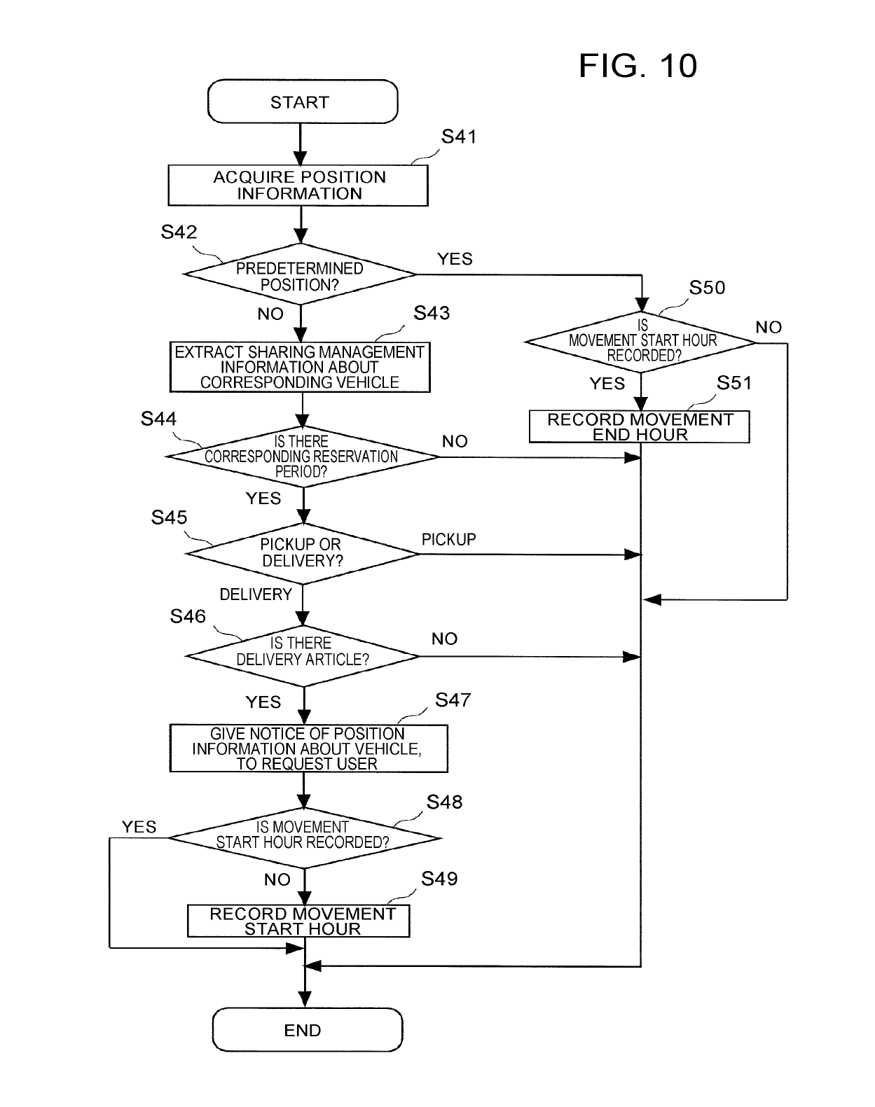

Next, a flowchart of FIG. 10 will be described. FIG. 10 is a flowchart showing an exemplary announcement process when the vehicle 30 moves after the loading completion. By the process of FIG. 10, a notice of the position information about the moving vehicle is given to the request user that designates the vehicle 30 as the delivery destination of the pickup-delivery article, at a predetermined interval. Further, by the process of FIG. 10, a movement start hour and a movement end hour for the moved vehicle 30 are recorded.

In the flowchart of FIG. 10, the process is started, for example, at the time of a notice of engine start from the communication device 32 mounted on the vehicle 30. As described already, to the sharing management server 10, the communication device 32 gives a notice of the position information at the times of the start and stop of the engine, and during traveling, gives a notice of the position information about the vehicle at a regular interval or for each regular traveling distance.

The sharing management server 10 acquires the position information about the vehicle 30 given from the communication device 32 (S41). The sharing management server 10 temporarily stores the acquired position information in a predetermined region of the main storage device 12, in association with the hour information and the IP address of the communication device 32, and the like. Then, the sharing management server 10 determines whether the acquired position information is the parking position (predetermined position) of the vehicle 30 that is designated as the pickup-delivery destination (S42). For example, the sharing management server 10 gives a notice of the device ID (IP address or the like) of the communication device 32, to the center server 20, and requests the search of the vehicle 30 on which the communication device 32 is mounted. The center server 20 extracts the vehicle attribute information about the vehicle 30 on which the communication device 32 is mounted, by the search in the vehicle management database, and gives a notice of the extracted vehicle attribute information, to the sharing management server 10. The sharing management server 10 temporarily stores the given vehicle attribute information in a predetermined region of the main storage device 12, and determines whether the position information acquired in the process of S42 is the predetermined position, based on the parking position information (latitude, longitude) about the vehicle 30 that is included in the vehicle attribute information. In the case where the position information acquired in S41 is the parking position of the vehicle 30 (S42, “Yes”), the sharing management server 10 transitions to the process of S50. On the other hand, in the case where the position information acquired in S41 is not the parking position of the vehicle 30 (S42, “No”), the sharing management server 10 transitions to the process of S43.

In the process of S43, the sharing management server 10 extracts the sharing management information about the vehicle 30 on which the communication device 32 is mounted, based on the IP address (device ID) or the like of the communication device 32. The extracted sharing management information is temporarily stored in a predetermined region of the main storage device 12. Then, the sharing management server 10 determines whether there is a reservation period corresponding to the hour information (including date) at the current time, from the extracted sharing management information (S44). In the case where there is a reservation period including the hour information at the current time (S44, “Yes”), the sharing management server 10 transitions to S45. On the other hand, in the case where there is no reservation period including the hour information at the current time (S44, “No”), the sharing management server 10 ends the process of FIG. 10.

In the process of S45, the sharing management server 10 determines whether the use form in the reservation period corresponding to the hour information at the current time is the delivery or the pickup. In the case where the use form in the reservation period corresponding to the hour information at the current time is the delivery (S45, “Delivery”), the sharing management server 10 transitions to S46. On the other hand, in the case where the use form in the reservation period corresponding to the hour information at the current time is the pickup (S45, “Pickup”), the sharing management server 10 ends the process of FIG. 10. In the process of S46, the sharing management server 10 determines whether there is a delivery article in the luggage compartment or the like of the vehicle. For example, in the case where the loading completion hour is recorded and the unloading completion hour is not recorded in the placing state field for the reservation period corresponding to the hour information at the current time, the sharing management server 10 determines that there is a delivery article in the luggage compartment or the like of the vehicle. Otherwise, the sharing management server 10 determines that there is no delivery article in the luggage compartment or the like of the vehicle. In the case where there is a delivery article in the luggage compartment or the like of the vehicle (S46, “Yes”), the sharing management server 10 transitions to the process of S47. On the other hand, in the case where there is no delivery article in the luggage compartment or the like of the vehicle (S46, “No”), the sharing management server 10 ends the process of FIG. 10.

In the process of S47, the sharing management server 10 gives a notice of the position information about the vehicle 30 acquired in the process of S41, to the request user. For example, the sharing management server 10 identifies the requester terminal 40 from the sharing management information extracted in the process of S43, and gives the notice of the position information about the vehicle 30, to the identified requester terminal 40. After receiving the notice from the sharing management server 10, the requester terminal 40, for example, activates the navigation application, and displays the position information about the vehicle 30, on a map screen. The request user watches the position of the vehicle 30 displayed on the map screen, and thereby, can know the vehicle position at the current time of the vehicle 30 that is designated as the pickup-delivery destination. After the process of S47, the process of FIG. 10 transitions to S48. In the process of S47, the sharing management server 10 may give a notice of an expected hour when the moved vehicle 30 will return to the predetermined position, based on the inter-point distance between the acquired position information about the vehicle 30 and the predetermined position (parking position). The process of S47 that is executed by the sharing management server 10 corresponds to an exemplary management technique of “giving a notice of the position information about the vehicle, to the terminal of the reservation source for which the reservation for the use of the pickup or delivery of the pickup-delivery article is accepted, when the processor detects the movement of the vehicle in the state where the pickup-delivery article is placed on the one or more regions”.

In the process of S48, the sharing management server 10 determines whether the movement start hour for the vehicle 30 is recorded. For example, the sharing management server 10 identifies the requester ID from the sharing management information extracted in the process of S43, and identifies the charging management information corresponding to the requester ID. Then, the sharing management server 10 identifies the vehicle movement field corresponding to the vehicle ID of the vehicle 30 and the reservation period in the charging management information. In the case where the movement start hour is stored in the vehicle movement field (S48, “Yes”), the sharing management server 10 determines that the movement start hour is already recorded, and ends the process of FIG. 10. On the other hand, in the case where the movement start hour is not stored in the vehicle movement field (S48, “No”), the sharing management server 10 determines that the movement start hour is not recorded, and transitions to the process of S49. In the process of S49, the sharing management server 10 records the movement start hour in the vehicle movement field corresponding to the vehicle ID of the vehicle 30 and the reservation period in the charging management information. For example, the sharing management server 10 records the hour information when the position information is acquired in the process of S41, as the movement start hour. After the process of S49, the process of FIG. 10 ends.

In the process of S50, the same process as the process of S48 is performed. In the case where the movement start hour is not stored in the vehicle movement field (S50, “No”), the sharing management server 10 determines that the movement start hour is not recorded, and ends the process of FIG. 10. On the other hand, in the case where the movement start hour is stored in the vehicle movement field (S50, “Yes”), the sharing management server 10 determines that the movement start hour is already recorded, and transitions to the process of S51. In the process of S51, the sharing management server 10 records the movement end hour in the vehicle movement field corresponding to the vehicle ID of the vehicle 30 and the reservation period in the charging management information. For example, the sharing management server 10 records the hour information when the position information is acquired in the process of S41, as the movement end hour. After the process of S51, the process of FIG. 10 ends.

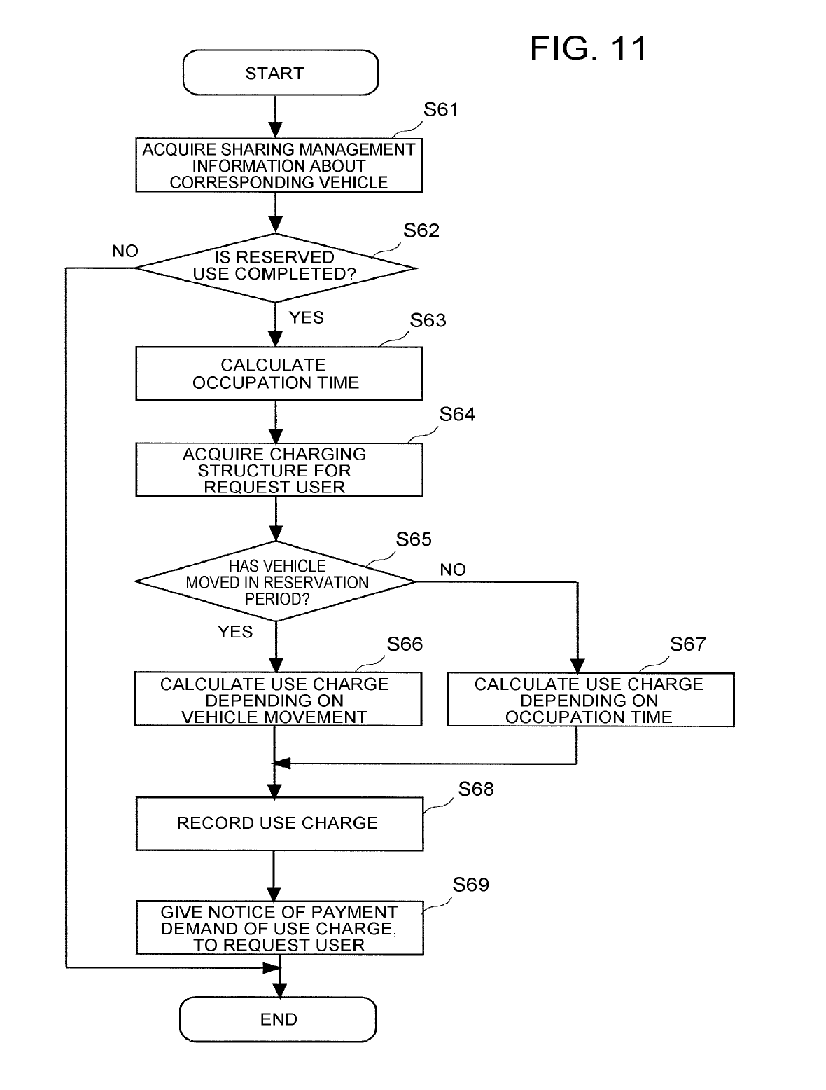

Next, a flowchart of FIG. 11 will be described. FIG. 11 is a flowchart showing an exemplary charging and billing process. The process exemplified in FIG. 11 is provided mainly by the information processing function of the charging processing unit 140. By the process of FIG. 11, the use charge that varies depending on the occupation time of the luggage compartment or the like for the pickup-delivery article is demanded to the request user.

In the flowchart of FIG. 11, the process is started, for example, when the use charge is demanded to the request user. For example, the process is started when the request user records an acceptance completion notice through the requester terminal 40. Further, for example, the process is started when the pickup-delivery person records a pickup-delivery completion notice through the pickup-delivery person terminal 50. The acceptance completion notice from the requester terminal 40 and the pickup-delivery completion notice from the pickup-delivery person terminal 50 include the identification information (vehicle ID) about the vehicle 30 to be locked and unlocked. After the acceptance completion notice is recorded, the “COMPLETION” status is recorded in the requester status of the sharing management information. Similarly, after the pickup-delivery completion notice is recorded, the “COMPLETION” status is recorded in the business operator status of the sharing management information.

The sharing management server 10 acquires the sharing management information about the vehicle after the acceptance completion notice is recorded or after the pickup-delivery completion notice is recorded (S61). Then, the sharing management server 10 determines whether the reserved use is completed in the sharing management information about the vehicle (S62). For example, in the case where the use form field has “DELIVERY” with respect to the reservation period for the recording of the acceptance completion notice and where the loading completion hour and the unloading completion hour are recorded in the placing state field, the sharing management server 10 determines that the reserved use for the delivery is completed. Otherwise, with respect to the reservation period for the recording of the acceptance completion notice, the sharing management server 10 determines that the reserved use is not completed. Similarly, for example, in the case where the use form field has “PICKUP” with respect to the reservation period for the recording of the pickup-delivery completion notice and where the loading completion hour and the unloading completion hour are recorded in the placing state field, the sharing management server 10 determines that the reserved use for the pickup is completed. Otherwise, with respect to reservation period for the recording of the pickup-delivery completion notice, the sharing management server 10 determines that the reserved use is not completed.

In the case where the sharing management server 10 determines that the reserved use of the vehicle is completed (S62, “Yes”), the sharing management server 10 transitions to the process of S63. On the other hand, in the case where the sharing management server 10 determines that the reserved use of the vehicle is not completed (S62, “No”), the sharing management server 10 ends the process of FIG. 11.

In the process of S63, the sharing management server 10 calculates the occupation time for the pickup-delivery article of the luggage compartment or the like used as the pickup-delivery destination. For example, the sharing management server 10 calculates the occupation time of the luggage compartment or the like by the minute, from the loading completion hour and unloading completion hour recorded in the placing field of the sharing management information. Then, the sharing management server 10 records the calculated occupation time in the charging management information. Here, the detection information about the pickup-delivery article from the sensor is recorded in the placing field of the sharing management information. Accordingly, it can be said that the process of S63 that is executed by the sharing management server 10 is an example of “identifying an occupation time for the pickup-delivery article placed on the one or more regions, based on the detection information”. For example, the sharing management server 10 identifies the charging management information corresponding to the requester ID, based on the requester ID corresponding to the reservation period. Then, the sharing management server 10 stores the calculated occupation time in the occupation period field corresponding to the reservation period in the charging management information. After the process of S63, the process of FIG. 11 transitions to the process of S64.

In the process of S64, the sharing management server 10 acquires the charging structure for the request user. For example, the sharing management server 10 acquires the identification number of the price table stored in the charging structure field of the charging management information that is identified in the process of S63. Then, the sharing management server 10 acquires the price table corresponding to the identification number by referring to the auxiliary storage device 13, and temporarily stores the price table in a predetermined region of the main storage device 12. After the process of S64, the process of FIG. 11 transitions to the process of S65.

In the process of S65, the sharing management server 10 determines whether the vehicle has moved in the reservation period. For example, in the case where the movement start hour and the movement end hour are stored in the vehicle movement field of the charging management information, the sharing management server 10 determines that the vehicle has moved in the reservation period. For example, in the case where the movement start hour and the movement end hour are not stored in the vehicle movement field of the charging management information, the sharing management server 10 determines that the vehicle has not moved in the reservation period. In the case where the sharing management server 10 determines that the vehicle has moved in the reservation period (S65, “Yes”), the sharing management server 10 transitions to the process of S66. On the other hand, in the case where the sharing management server 10 determines that the vehicle has not moved in the reservation period (S65, “No”), the sharing management server 10 transitions to the process of S67.

In the process of S66, the sharing management server 10 calculates the use charge depending on the vehicle movement. The use charge is calculated based on the charging rate set in the price table that is acquired in the process of S64 and the occupation time. The calculated use charge is transferred to the process of S68. As the calculation of the use charge depending on the vehicle movement, for example, the sharing management server 10 calculates the movement start hour and the movement time of the vehicle from the movement start hour in units of minutes. Then, as the object of the charging time, the sharing management server 10 sets an occupation time resulting from subtracting the movement time from the occupation time (by the minute) stored in the occupation period field. Alternatively, as the object of the charging time, the sharing management server 10 may set a period after the start hour (loading completion hour) of the occupation period and before the movement start hour. Further, in the case where the vehicle has moved, the sharing management server 10 may calculate the use charge depending on the occupation time, by multiplying the charging rate in the price table by a predetermined discount.

In the process of S67, the sharing management server 10 calculates the use charge depending on the occupation time for the pickup-delivery article. The use charge is calculated based on the charging rate set in the price table acquired in the process of S64 and the occupation time. In the calculation of the use charge, an overtime after the reservation end hour of the reservation period is calculated for an additional charge. The charging rate corresponding to the additional charge is previously set in the price table. For example, the sharing management server 10 compares the end hour (unloading completion hour) of the occupation period and the end hour of the reservation period. Then, in the case where the end hour of the occupation period is later than the end hour of the reservation period, the sharing management server 10 sets a period after the end hour of the reservation period and before the end hour of the occupation time, as the object of the charging time for the additional charge. The sharing management server 10 calculates the use charge depending on the occupation time including the overtime after the end hour of the reservation period, and transfers the calculated use charge to the process of S68.

In the process of S68, the sharing management server 10 records the use charge transferred from the process of S66 or S67, in the use charge field of the charging management information. After the process of S68, the sharing management server 10 gives a notice of the use charge to the requester terminal 40 of the request user, and gives a notice of a payment demand of the use charge (S69). After the notice of the payment demand of the use charge, the sharing management server 10 stores the “UNPAID” status in the payment status field of the charging management information. After the process of S69, the process of FIG. 11 ends.

After receiving the notice of the use charge and the notice of the payment charge through the requester terminal 40, the request user makes the payment of the demanded use charge, through a predetermined payment account, for example. The sharing management server 10 or the computer that cooperates with the sharing management server 10 confirms the payment of the use charge by the request user, and thereafter, stores the “PAID” status in the payment status field of the charging management information. In the process of S63 that is executed by the sharing management server 10, the loading completion hour and unloading completion hour recorded in the placing field of the sharing management information corresponds to “detection information about the pickup-delivery article for the one or more regions” detected from the sensors that detect the placing state of the pickup-delivery article. Therefore, it can be said that the process of S69 that is executed by the sharing management server 10 corresponds to an example of “demanding payment of a use charge calculated based on the occupation time, to a terminal of a reservation source for which the reservation for the use for the pickup or delivery of the pickup-delivery article is accepted”. The process of S65 that is executed by the sharing management server 10 corresponds to an example of “detecting movement of the vehicle, based on change in position information about the vehicle in connection with time elapse”. The process of S66 that is executed by the sharing management server 10 corresponds to an exemplary management technique of “reducing the use charge calculated based on the occupation time, by some or all of the use charge, when the processor detects the movement of the vehicle in a state where the pickup-delivery article is placed on the one or more regions”.

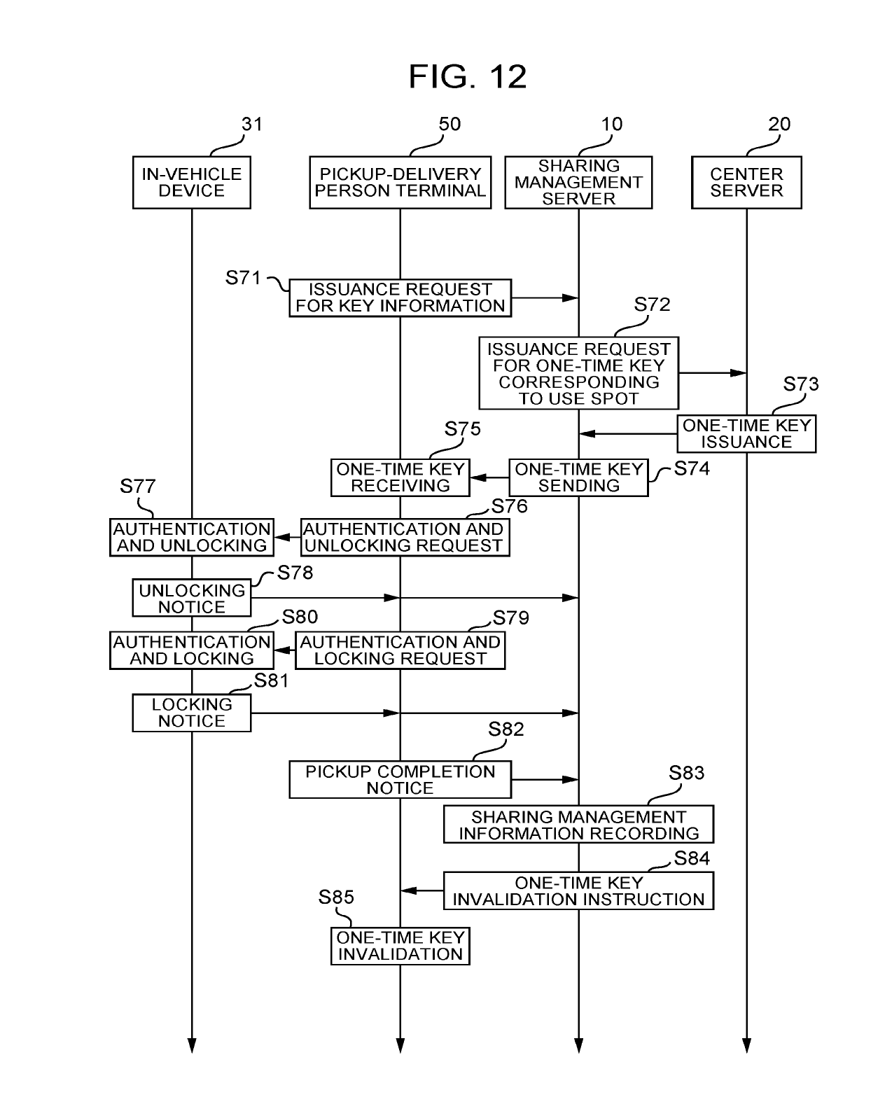

Next, a flow of a pickup-delivery process using the key information in the trunk sharing system 1 will be described. FIG. 12 is a sequence diagram showing an exemplary flow of a pickup-delivery process to the vehicle 30 using the key information. In an example shown in FIG. 12, the center server 20 receives the issuance request for the key information from the sharing management server 10, and thereafter, issues the key information. It is assumed that the information (the name of the vehicle manufacturer, the vehicle type, the color or vehicle image, the number and the like) for identifying the vehicle 30 that is the pickup-delivery destination, the parking position information (the parking area address, the parking position and the like), the disposition region for the pickup-delivery article, and the like are disposed to the pickup-delivery person terminal 50.

For example, the pickup-delivery person checks the address and the like indicated by the parking position information, with a car navigation system or the like, and reaches the parking position of the vehicle 30 designated as the pickup-delivery destination, on the designated date and hour. Then, the pickup-delivery person identifies the vehicle 30 designated as the pickup-delivery destination, from the information for identifying the vehicle 30, and transmits the issuance request for the key information for unlocking and locking the luggage compartment door or vehicle cabin door corresponding to the disposition region for the pickup-delivery article, to the sharing management server 10, through the pickup-delivery person terminal 50 (S71). The issuance request for the key information from the pickup-delivery person terminal 50 includes at least the information for identifying the vehicle 30 designated as the delivery destination.

The sharing management server 10 accepts the issuance request for the key information from the pickup-delivery person terminal 50, and requests the issuance of the one-time key to the center server 20. The sharing management server 10 identifies the sharing management information about the vehicle 30, based on the information that is the information for identifying the vehicle 30 and that is included in the issuance request for the key information from the pickup-delivery person terminal 50, and identifies the disposition region (use spot) for the pickup-delivery article. Then, the sharing management server 10 requests the issuance of the one-time key including the disposition region information about the pickup-delivery article and the identification information (vehicle ID) about the vehicle 30, to the center server 20 (S72).

The center server 20 accepts the issuance request for the one-time key transmitted from the sharing management server 10, and issues the key information (S73). The center server 20 issues the key information for making the pickup-delivery person terminal 50 function as a temporary electronic key, at least based on the identification information about the vehicle 30 that is included in the issuance request for the one-time key, the disposition region information about the pickup-delivery article, and the hour information when the issuance request is accepted. The issuance of the key information corresponding to the disposition region information about the pickup-delivery article may be previously set between the sharing management server 10 and the center server 20. The center server 20 can issue the key information corresponding to the disposition region (for example, the hood, the assistant driver's seat, the backseat on the assistant driver's seat side, the backseat on the driver's seat side or the luggage compartment) for the pickup-delivery article.

The center server 20 transfers the issued key information to the sharing management server 10 as the one-time key, and then, the sharing management server 10 sends the one-time key transferred from the center server 20, to the pickup-delivery person terminal 50 (S74). The pickup-delivery person terminal 50 receives the one-time key sent from the sharing management server 10, and temporarily stores the one-time key in a predetermined region of the main storage device 52 (S75). The one-time key may be directly issued from the center server 20 to the pickup-delivery person terminal 50.

The pickup-delivery person makes the pickup-delivery person terminal 50 with the stored key information operate as a temporary electronic key, and transmits the unlocking request for the door corresponding to the disposition region for the pickup-delivery article (S76). The key unit 80 of the in-vehicle device 31 mounted on the vehicle 30 executes the authentication in connection with the unlocking request from the pickup-delivery person terminal 50. When the authentication succeeds, the key unit 80 transmits the locking-unlocking signal and the key ID to the locking-unlocking device 90. The locking-unlocking device 90 performs the unlocking process in accordance with the locking-unlocking signal and key ID transmitted from the key unit 80, so that the door or the like corresponding to the use spot of the vehicle 30 is unlocked (S77). The unlocking notice is given from the in-vehicle device 31 to the pickup-delivery person terminal 50 and the sharing management server 10 (S78). For example, the sharing management server 10 may acquire the hour information when the unlocking notice is given, and may record the hour information in the sharing management information about the vehicle 30. The pickup-delivery person opens the door or the like of the vehicle 30 unlocked, puts the delivery article in the disposition region or picks up the pickup article disposed in the disposition region, and closes and locks the door or the like (S79). In the locking, processes similar to the processes described in S77 and S78 are performed (S80, S81). For example, the pickup-delivery person transmits the pickup completion notice to the sharing management server 10 through the pickup-delivery person terminal 50 (S82). Based on the pickup completion notice, the sharing management server 10, for example, records “COMPLETION” in the business operator status with respect to the reservation period corresponding to the sharing management information about the vehicle 30 (S83).

The sharing management server 10 invalidates the one-time key held in the pickup-delivery person terminal 50 (S84). For example, the sharing management server 10 gives an erasure instruction for the held key information, to the pickup-delivery person terminal 50, at the time of the recording in the sharing management information in connection with the pickup-delivery completion notice. The pickup-delivery person terminal 50 erases the key information about the one-time key temporarily held in the predetermined region of the main storage device 52, for example, through processing of the predetermined app that receives the erasure instruction for the key information (S85). The pickup-delivery person terminal 50 may erase the key information about the one-time key temporarily held in the predetermined region of the main storage device 52, at the time of the transmission of the pickup-delivery completion notice.

The flow of the process exemplified in FIG. 12 is similarly applied to the requester terminal 40 of the request user that collects the delivery article put in the luggage compartment or the like of the vehicle or puts the pickup article in the luggage compartment or the like. Here, in the process of S82, the information to be transmitted from the requester terminal 40 to the sharing management server 10 is a receiving completion notice.

As described above, the sharing management server 10 according to the embodiment can identify the placing state of the pickup-delivery article in the luggage compartment or the like, based on the information from the sensors mounted on the vehicle that is reserved as the pickup-delivery destination. The sharing management server 10 can calculate the occupation time for the pickup-delivery article, from the identified placing state of the pickup-delivery article, and can demand, to the request user, the price that varies depending on the calculated occupation time. As a result, with the sharing management server 10 according to the embodiment, it is possible to provide the charging technology that allows the securement of fairness among a plurality of users.

The sharing management server 10 can identify the remaining time before the end time of the use reservation period, based on the occupation time. Then, the sharing management server 10 can announce the remaining time before the end time of the use reservation period, to the request user. The sharing management server 10 can give a notice that there is a parcel in the vehicle, to the plurality of users that uses the luggage compartment or the like, and can prompt an early taking.

The sharing management server 10 can acquire the schedule of the use of the vehicle, from the possessor terminal 60 of the vehicle owner. Then, when the reservation accepted from the request user falls within a period during which the vehicle is likely to be used, the sharing management server 10 can apply the price table in which the charging rate is set to a relatively high rate. When the reservation accepted from the request user falls within a period during which the vehicle is likely to be used, the sharing management server 10 can increase the use charge based on the occupation time, at a predetermined rate. By the increase in the use charge, it is possible to expect to restrain an extension of the occupation period for the pickup-delivery article in the vehicle designated as the pickup-delivery destination, for the plurality of users that uses the luggage compartment or the like.

The sharing management server 10 can acquire the position information at the time of the movement of the vehicle 30, through the communication device 32. The sharing management server 10 can identify the movement start hour and movement end hour for the vehicle, from change in the acquired position information in connection with time elapse. When the vehicle moves in a state where the pickup-delivery article is placed on the luggage compartment or the like, the sharing management server 10 can decrease the use charge for the request user, that is, can return some of the use charge depending on the occupation time, based on the movement time calculated based on the movement start hour and the movement end hour. As a result, it is possible to compensate, by the use charge, a disadvantage of the user relevant to the acceptance of the pickup-delivery article when the vehicle moves in the state where the pickup-delivery article is placed on the luggage compartment or the like.

When the vehicle moves in the state where the pickup-delivery article is placed on the luggage compartment or the like, the sharing management server 10 can give the notice of the position information about the vehicle to the requester terminal 40 of the request user. For example, the request user can know the given position information about the vehicle on the map screen, through the navigation application mounted on the requester terminal 40. Therefore, it is possible to increase usability for the request user when the vehicle moves in the state where the pickup-delivery article is placed on the luggage compartment or the like.

The sharing management server 10 can acquire the position information about the request user through the requester terminal 40. The sharing management server 10 can estimate the required time to collect the pickup-delivery article placed on the luggage compartment or the like, from the position information about the request user and the parking position of the vehicle 30 designated as the pickup-delivery destination. Then, the sharing management server 10 can calculate the expected amount of the use charge, based on the estimated required time, and can give the notice of the expected amount to the request user. The request user can know the use charge in advance, and therefore, it is possible to increase convenience for the request user.

The sharing management server 10 can estimate the expected collection hour for the pickup-delivery article based on the calculated required time, and can give the notice of the estimated expected collection hour, to the possessor terminal 60 of the vehicle owner. For example, the vehicle owner can replan the use schedule for the vehicle 30, based on the given expected collection hour.

4. Modifications

The above embodiment is an example, and the present disclosure can be appropriately modified to be executed, without departing from the gist of the present disclosure.

First Modification

In the example described in the embodiment, when the authentication process succeeds in the key unit 80, the vehicle 30 is locked and unlocked by the locking-unlocking device 90. In the first modification, the process in the key unit 80 may be executed by the locking-unlocking device 90. That is, the locking-unlocking device 90 may include a control unit (ECU) for authenticating the authentication information received from the requester terminal 40 or the like, and when the authentication of the requester terminal 40 or the like succeeds, the control unit may transmit the unlocking command or the locking command to the body ECU 94 through the in-vehicle network such as a CAN. With the trunk sharing system 1 in the first modification, it is possible to use the trunk sharing by a simple configuration, without providing the key unit 80.

Second Modification

In the embodiment, when the requester terminal 40 or the like receives the key information issued by the center server 20 and the authentication of the requester terminal 40 or the like succeeds based on the authentication information of the received key information, the locking-unlocking signal is transmitted from the key unit 80 to the locking-unlocking device 90, so that the vehicle 30 is locked and unlocked. In the second modification, the authentication information is not information for authenticating the requester terminal 40 or the like, and includes the information of the key ID for unlocking and locking the vehicle 30.

In this case, the requester terminal 40 or the like receives the key information including the key ID for locking and unlocking the vehicle 30, from the center server 20 or the like, and transmits the received key ID to the locking-unlocking device 90, together with the locking-unlocking signal. The locking-unlocking device 90 compares the received key ID and the key ID previously stored in the locking-unlocking device 90, and locks and unlocks the vehicle 30 in the case of the coincidence. The key ID may be encrypted to be transmitted and received between the requester terminal 40 or the like and the center server 20 or the like or the locking-unlocking device 90. For example, the center server 20 may generate the one-time key by encrypting the key ID and the hour information with a predetermined algorism. The locking-unlocking device 90 may decrypt the received one-time key with the same predetermined algorism as the algorism in the center server 20, and may compare the one-time key with the key ID previously stored in the locking-unlocking device 90. When a predetermined time has elapsed since the receiving of the one-time key, the requester terminal 40 or the like may erase and invalidate the one-time key. With the trunk sharing system 1 in the first modification, by adopting the one-time key generated from the key ID and the hour information as the key information, the center server 20 or the like can transmit temporary valid key information to the requester terminal 40 or the like, for each issuance request.

Third Modification

In the embodiment and the second modification, the center server 20 transmits the authentication information for the requester terminal 40 or the like that corresponds to the fixed authentication information specific to the key unit 80 or the key ID previously stored in the locking-unlocking device 90 of the vehicle 30. However, the authentication information between the requester terminal 40 or the like and the key unit 80 is not limited to the above authentication information. In the third modification, for example, the center server 20 may generate new authentication information and issue the new authentication information to the requester terminal 40 or the like, whenever the center server 20 accepts the issuance request for the key information from the requester terminal 40 or the like. In this case, through the communication device 32, the center server 20 or the like stores the vehicle-side authentication information for the key unit 80 that corresponds to the new authentication information, in the key unit 80. The key unit 80 is connected to the communication device 32 through the in-vehicle network such as a CAN. However, for example, the center server 20 may generate the authentication information to be issued to the requester terminal 40 or the like, from the identification information for identifying the vehicle 30 and the hour information, and then may transfer the authentication information and the hour information to the requester terminal 40 or the like. In this case, the key unit 80 of the vehicle 30 may generate the vehicle-side authentication information with the same algorism as the algorism in the center server 20. The requester terminal 40 or the like may send the authentication information issued as the key information and the hour information, to the key unit 80, and the authentication of the requester terminal 40 or the like is performed.

Others

In the trunk sharing systems 1 in the embodiment and the modifications, in the locking and unlocking of the vehicle 30, it is assumed that only the unlocking and locking controls of the luggage compartment door are performed and the vehicle cabin door is kept in the locked state without the unlocking and locking controls, in consideration of security. Therefore, for example, in a vehicle 30 having a body structure in which the luggage compartment and the vehicle cabin are not separated, that is, in a so-called minivan type, the possessor of the vehicle 30, users and the like can have fear about the security because the unlocking of the luggage compartment door allows the vehicle cabin to be accessed.

Hence, in the vehicle 30 in which the luggage compartment and the vehicle cabin are not separated, when the luggage compartment door is opened, a dashboard camera or the like that can record also the vehicle cabin may record a moving image of the vehicle cabin, and whether the intrusion from the luggage compartment to the vehicle cabin has been performed may be determined based on the recorded moving image. For example, in the case of determining that the intrusion from the luggage compartment to the vehicle cabin has been performed, an ECU to control the dashboard camera performs saving of the recorded moving image, actuation of an in-vehicle alarm, notification to the business operator, notification to the possessor of the vehicle, and the like. On the other hand, in the case of determining that the intrusion to the vehicle cabin has not been performed, the ECU may erase the recorded moving image, at the time when the luggage compartment door is closed and locked. As part of user service, the dashboard camera may transmit the recorded moving image to the possessor terminal 60 of the vehicle owner of the vehicle 30, and the like, regardless of whether the intrusion to the vehicle cabin has been performed.

Computer-Readable Recording Medium

A program that realizes one of the above functions in an information processing device, a machine or a device (hereinafter, referred to as a computer or the like) can be recorded in a recording medium that is readable for the computer or the like. The computer or the like reads and executes the program in the recording medium, and thereby, can provide the function.

Here, the recording medium that is readable for the computer or the like is a recording medium that stores information such as data or a program by electric, magnetic, optical, mechanical or chemical action and that allows the computer or the like to read the information. As recording media that are removable from the computer or the like, for example, there are a flexible disc, a magnetic-optical disc, a CD-ROM, a CD-R/W, a DVD, a Blu-ray disc, a DAT, an 8-mm tape and a memory card such as a flash memory. Further, as recording media that are fixed in the computer or the like, there are a hard disc, a ROM and the like.

What is claimed is:

1. An information system configured to manage use of one or more regions in a vehicle for pickup or delivery, the vehicle being permitted to be used as a pickup-delivery destination of a pickup-delivery article, the information system comprising:
a processor, the processor being configured to
accept a reservation for the use of the one or more regions for the pickup or delivery of the pickup-delivery article;
acquire detection information, from a sensor configured to detect a placing state of the pickup-delivery article in the vehicle, the detection information being information about the placing state of the pickup-delivery article for the one or more regions;
identify an occupation time for the pickup-delivery article placed on the one or more regions, based on the detection information; and
give a notice of information to a terminal of a reservation source of the reservation for the use for the pickup or delivery of the pickup-delivery article, the information being relevant to payment of a use charge calculated based on the occupation time.

2. The information system according to claim 1, wherein the processor is configured to identify a remaining time before an end time of the reservation for the use, based on the occupation time, and to give a notice of information to the terminal of the reservation source, the information being relevant to the remaining time before the end time of the reservation for the use.

3. The information system according to claim 1, wherein:
the processor is configured to acquire a schedule of use of the vehicle, from a terminal of a possessor of the vehicle; and
the processor is configured to increase the use charge calculated based on the occupation time, at a predetermined rate, when the reservation for the use falls within a period during which the vehicle is scheduled to be used.

4. The information system according to claim 1, wherein:
the processor is configured to detect movement of the vehicle, based on change in position information about the vehicle in connection with time elapse; and
the processor is configured to reduce the use charge calculated based on the occupation time, by some or all of the use charge, when the processor detects the movement of the vehicle in a state where the pickup-delivery article is placed on the one or more regions.

5. The information system according to claim 4, wherein the processor is configured to give a notice of the position information about the vehicle, to the terminal of the reservation source, when the processor detects the movement of the vehicle in the state where the pickup-delivery article is placed on the one or more regions.

6. The information system according to claim 1, wherein:
the processor is configured to acquire position information from the terminal of the reservation source;
the processor is configured to calculate a required time to collect the pickup-delivery article, based on a parking position of the vehicle and the position information acquired from the terminal of the reservation source, in a state where the pickup-delivery article is placed on the one or more regions; and
the processor is configured to give a notice of an expected amount of the use charge, to the terminal of the reservation source, the expected amount of the use charge being calculated based on the required time.

7. The information system according to claim 6, wherein:
the processor is configured to estimate an expected collection hour for the pickup-delivery article placed on the one or more regions, based on the required time; and
the processor is configured to give a notice of the expected collection hour, to a terminal of a possessor of the vehicle.

8. An information processing method of using an information system configured to manage use of one or more regions in a vehicle for pickup or delivery, the vehicle being permitted to be used as a pickup-delivery destination of a pickup-delivery article, the information system including a processor, the information processing method comprising:
accepting, by the processor, a reservation for the use of the one or more regions for the pickup or delivery of the pickup-delivery article;
acquiring, by the processor, detection information, from a sensor configured to detect a placing state of the pickup-delivery article in the vehicle, the detection information being information about the placing state of the pickup-delivery article for the one or more regions;
identifying, by the processor, an occupation time for the pickup-delivery article placed on the one or more regions, based on the detection information; and
giving, by the processor, a notice of information to a terminal of a reservation source of the reservation for the use for the pickup or delivery of the pickup-delivery article, the information being relevant to payment of a use charge calculated based on the occupation time.

9. The information processing method according to claim 8, further comprising identifying, by the processor, a remaining time before an end time of the reservation for the use, based on the occupation time, and giving, by the processor, a notice of information to the terminal of the reservation source, the information being relevant to the remaining time before the end time of the reservation for the use.

10. The information processing method according to claim 8, further comprising:
acquiring, by the processor, a schedule of use of the vehicle, from a terminal of a possessor of the vehicle; and
increasing, by the processor, the use charge calculated based on the occupation time, at a predetermined rate, when the reservation falls within a period during which the vehicle is scheduled to be used.

11. The information processing method according to claim 8, further comprising:
detecting, by the processor, movement of the vehicle, based on change in position information about the vehicle in connection with time elapse; and
reducing, by the processor, the use charge calculated based on the occupation time, by some or all of the use charge, when the processor detects the movement of the vehicle in a state where the pickup-delivery article is placed on the one or more regions.

12. The information processing method according to claim 11, further comprising giving, by the processor, a notice of the position information about the vehicle, to the terminal of the reservation source, when the processor detects the movement of the vehicle in the state where the pickup-delivery article is placed on the one or more regions.

13. The information processing method according to claim 8, further comprising:
acquiring, by the processor, position information from the terminal of the reservation source;
calculating, by the processor, a required time to collect the pickup-delivery article, based on a parking position of the vehicle and the position information acquired from the terminal of the reservation source, in a state where the pickup-delivery article is placed on the one or more regions; and
giving, by the processor, a notice of an expected amount of the use charge, to the terminal of the reservation source, the expected amount of the use charge being calculated based on the required time.

14. The information processing method according to claim 13, further comprising:
estimating, by the processor, an expected collection hour for the pickup-delivery article placed on the one or more regions, based on the required time; and
giving, by the processor, a notice of the expected collection hour, to a terminal of a possessor of the vehicle.

15. A non-transitory readable recording medium holding a program that makes a processor execute an information processing method, the information processing method being a method for an information system configured to manage use of one or more regions in a vehicle for pickup or delivery, the vehicle being permitted to be used as a pickup-delivery destination of a pickup-delivery article, the program making the processor execute a control process for the information system, the control process comprising:
accepting a reservation for the use of the one or more regions for the pickup or delivery of the pickup-delivery article;
acquiring detection information, from a sensor configured to detect a placing state of the pickup-delivery article in the vehicle, the detection information being information about the placing state of the pickup-delivery article for the one or more regions;
identifying an occupation time for the pickup-delivery article placed on the one or more regions, based on the detection information; and
giving a notice of information to a terminal of a reservation source of the reservation for the use for the pickup or delivery of the pickup-delivery article, the information being relevant to payment of a use charge calculated based on the occupation time.

16. The non-transitory readable recording medium according to claim 15, wherein the control process further comprises identifying a remaining time before an end time of the reservation for the use, based on the occupation time, and giving a notice of information to the terminal of the reservation source, the information being relevant to the remaining time before the end time of the reservation for the use.

17. The non-transitory readable recording medium according to claim 15, wherein the control process further comprises: acquiring a schedule of use of the vehicle, from a terminal of a possessor of the vehicle; and increasing the use charge calculated based on the occupation time, at a predetermined rate, when the reservation falls within a period during which the vehicle is scheduled to be used.

18. The non-transitory readable recording medium according to claim 15, wherein the control process further comprises: detecting movement of the vehicle, based on change in position information about the vehicle in connection with time elapse; and reducing the use charge calculated based on the occupation time, by some or all of the use charge, when the processor detects the movement of the vehicle in a state where the pickup-delivery article is placed on the one or more regions.

19. The non-transitory readable recording medium according to claim 18, wherein the control process further comprises giving a notice of the position information about the vehicle, to the terminal of the reservation source, when the processor detects the movement of the vehicle in the state where the pickup-delivery article is placed on the one or more regions.

20. The non-transitory readable recording medium according to claim 15, wherein the control process further comprises: acquiring position information from the terminal of the reservation source; calculating a required time to collect the pickup-delivery article, based on a parking position of the vehicle and the position information acquired from the terminal of the reservation source, in a state where the pickup-delivery article is placed on the one or more regions; and giving a notice of an expected amount of the use charge, to the terminal of the reservation source, the expected amount of the use charge being calculated based on the required time.

21. The non-transitory readable recording medium according to claim 20, wherein the control process further comprises: estimating an expected collection hour for the pickup-delivery article placed on the one or more regions, based on the required time; and giving a notice of the expected collection hour, to a terminal of a possessor of the vehicle.
